(19) United States
(12) Patent Application Publication
(10) Pub. No.: US 2007/0127126 A1
(43) Pub. Date: Jun. 7, 2007

(54) Dielectric multilayer filter

(75) Inventor: Yoshiyuki Terada, Fujieda-city (JP)

Correspondence Address: HEDMAN & COSTIGAN P.C., 1185 AVENUE OF THE AMERICAS, NEW YORK, NY, 10036, US

(73) Assignee: MURAKAMI CORPORATION

(21) Appl. No.: 11/542,429

(22) Filed: Oct. 3, 2006

(30) Foreign Application Priority Data
Dec. 7, 2005 (JP) 2005-354191
Mar. 13, 2006 (JP) 2006-067250

(51) Int. Cl. G02B 1/10

(52) U.S. Cl. 359/586; 359/588

(57) ABSTRACT

To provide a dielectric multilayer filter, such as an IR cut filter and a red-reflective dichroic filter, that produces an effect of reducing incident-angle dependency and has a wide reflection band. A first dielectric multilayer film 30 is formed on the front surface of a transparent substrate 28, and a second dielectric multilayer film 32 is formed on the back surface of the transparent substrate 28. The width W1 of the reflection band of the first dielectric multilayer film 30 is set narrower than the width W2 of the reflection band of the second dielectric multilayer film 32. The half-value wavelength E2_{L} of the shorter-wavelength-side edge of the reflection band of the second dielectric multilayer film 32 is set between the half-value wavelength E1_{L} at the shorter-wavelength-side edge and the half-value wavelength E1_{H} at the longer-wavelength-side edge of the reflection band of the first dielectric multilayer film 30.

The disclosures of Japanese Patent Applications Nos. JP2005-354191 filed on Dec. 7, 2005 and No. JP2006-67250 filed on Mar. 13, 2006 including the specifications, drawings and abstracts are incorporated herein by reference in their entirety.

### BACKGROUND OF THE INVENTION

1. Field of the Invention

The present invention relates to a dielectric multilayer filter that produces an effect of reducing incident-angle dependency and has a wide reflection band.

2. Description of the Related Art

A dielectric multilayer filter is an optical filter that is composed of a stack of a plurality of kinds of thin films made of dielectric materials having different refractive indices and serves to reflect (remove) or transmit a component of a particular wavelength band in incident light taking advantage of light interference. For example, the dielectric multilayer filter is a so-called IR cut filter (infrared cut filter) used in a CCD camera for removing infrared light (light of wavelengths longer than about 650 nm), which adversely affects color representation, and transmitting visible light. Alternatively, the dielectric multilayer filter is a so-called dichroic filter used in a liquid crystal projector for reflecting light of a particular color in incident visible light and transmitting light of other colors.

FIG. 2 shows a structure of an IR cut filter using a conventional dielectric multilayer film. An IR cut filter 10 is composed of a substrate 12 made of an optical glass and low-refractive-index films 14 of SiO₂ and high-refractive-index films 16 of TiO₂ alternately stacked on the front surface of the substrate 12. FIG. 3 shows spectral transmittance characteristics of the IR cut filter 10. In FIG. 3, characteristics A and B represent the following transmittances, respectively.

Characteristic A: transmittance for an incident angle of 0 degrees

Characteristic B: transmittance of an average of p-polarized light and s-polarized light (n-polarized light) for an incident angle of 25 degrees

As can be seen from FIG. 3, infrared light (light having wavelengths longer than about 650 nm) is reflected and removed, and visible light is transmitted.

FIG. 4 is an enlarged view showing the characteristics within a band of 600 to 700 nm in FIG. 3. As can be seen from FIG. 4, the half-value wavelength (“half-value wavelength” refers to wavelength at which the transmittance is 50%) at the shorter-wavelength-side edge of the reflection band (“reflection band” refers to a band of high reflectance between the shorter-wavelength-side edge and the longer-wavelength-side edge) is shifted by as much as 19.5 nm between the case where the incident angle is 0 degrees (characteristic A) and the case where the incident angle is 25 degrees (characteristic B). In this way, in the conventional IR cut filter 10 shown in FIG. 2, the shorter-wavelength-side edge of the reflection band shifts largely (or depends largely on the incident angle). Therefore, if the IR cut filter is used for a CCD camera, there is a problem that the color tone of the taken image changes depending on the incident angle.

A dichroic filter using a conventional dielectric multilayer film has a structure similar to that shown in FIG. 2. That is, the dichroic filter is composed of a substrate 12 made of an optical glass and low-refractive-index films 14 of SiO₂ and high-refractive-index films 16 of TiO₂ alternately stacked on the front surface of the substrate 12. FIG. 31 shows spectral transmittance characteristics of the dichroic filter configured as a red-reflective dichroic filter. The characteristics are those in the case where an antireflection film is formed on the back surface of the substrate. In FIG. 31, characteristics A, B and C represent the following transmittances, respectively. Here, a normal incident angle of the dichroic filter is 45 degrees.

Characteristic A: transmittance of s-polarized light for an incident angle of 30 degrees

Characteristic B: transmittance of s-polarized light for an incident angle of 45 degrees

Characteristic C: transmittance of s-polarized light for an incident angle of 60 degrees

As can be seen from FIG. 31, the half-value wavelength at the shorter-wavelength-side edge of the reflection band is shifted by 35.9 nm toward longer wavelengths when the incident angle is 30 degrees (characteristic A) and by 37.8 nm toward shorter wavelengths when the incident angle is 45 degrees (characteristic C), compared with the case of the normal incident angle 45 degrees (characteristic B). A typical reflection band of the red-reflective dichroic filter has the shorter-wavelength-side edge at about 600 nm and the longer-wavelength-side edge at about 680 nm or longer. In particular, there is a problem that the color tone of the reflection light changes if the shorter-wavelength-side edge is shifted largely (by 37.8 nm) toward shorter wavelengths as in the case of the characteristic C.

A conventional technique for reducing the incident-angle dependency is described in the patent literature 1 described below. FIG. 5 shows a filter structure according to the technique. A dielectric multilayer filter 18 is composed of an optical glass substrate 20 and high-refractive-index films 22 of TiO₂ and low-refractive-index films 24 of Ta₂O₅ or the like having a refractive index about 0.3 lower than that of TiO₂ alternately stacked on the front surface of the substrate 20. Since the film of Ta₂O₅ or the like having a refractive index higher than that of commonly used SiO₂ is used as the low-refractive-index film, the refractive index (average refractive index) of the entire stack film increases, and the incident-angle dependency of the dielectric multilayer filter 18 is reduced compared with the dielectric multilayer filter 10 shown in FIG. 2.
[Patent literature 1] Japanese Patent Laid-Open No. 07-27907 (FIG. 1)

### SUMMARY OF THE INVENTION

If the technique described in the patent literature 1 is applied to the IR cut filter or red-reflective dichroic filter 10 shown in FIG. 2, and the low-refractive-index films 14 are made of a material having a refractive index higher than that of SiO₂, the refractive index (average refractive index) of the entire stack film increases, so that the incident-angle dependency can be reduced. However, since the difference in refractive index between the high-refractive-index films 16 and the low-refractive-index films 14 decreases, the reflection band becomes narrower, and there arises a problem that the IR cut filter or red-reflective dichroic filter cannot have a required reflection band.

The present invention is to solve the problems with the conventional technique described above and to provide a dielectric multilayer filter that produces an effect of reducing incident-angle dependency and has a wide reflection band.

A dielectric multilayer filter according to the present invention comprises: a transparent substrate; a first dielectric multilayer film having a predetermined reflection band formed on one surface of the transparent substrate; and a second dielectric multilayer film having a predetermined reflection band formed on the other surface of the transparent substrate, the width of the reflection band of the first dielectric multilayer film (the “width” refers to a bandwidth between the wavelength at the shorter-wavelength-side edge of the reflection band at which the transmittance is 50% and the wavelength at the longer-wavelength-side edge of the reflection band at which the transmittance is 50%) is set narrower than the width of the reflection band of the second dielectric multilayer film, and the shorter-wavelength-side edge of the reflection band of the second dielectric multilayer film is set between the shorter-wavelength-side edge and the longer-wavelength-side edge of the reflection band of the first dielectric multilayer film.

According to the present invention, the reflection band of the entire element is determined as the band between the shorter-wavelength-side edge of the reflection band of the first dielectric multilayer film and the longer-wavelength-side edge of the reflection band of the second dielectric multilayer film. Therefore, the width of the reflection band of the first dielectric multilayer film has no effect on the width of the reflection band of the entire element (in other words, the width of the reflection band of the entire element can be set independently of the width of the reflection band of the first dielectric multilayer film), so that the width of the reflection band of the first dielectric multilayer film can be set narrow. As a result, the shift of the shorter-wavelength-side edge of the reflection band of the entire element, which is determined as the shorter-wavelength-side edge of the reflection band of the first dielectric multilayer film, due to variations in incident angle is reduced, and the incident-angle dependency of the entire element can be reduced. On the other hand, the shorter-wavelength-side edge of the reflection band of the second dielectric multilayer film is masked by the reflection band of the first dielectric multilayer film, and thus, the incident-angle dependency of the shorter-wavelength-side edge of the reflection band of the second dielectric multilayer film has no effect on the reflection characteristics of the entire element. Thus, the width of the reflection band of the second dielectric multilayer film can be set wide, and as a result, it can be ensured that the entire element has a wide reflection band. In this way, according to the present invention, a dielectric multilayer filter is provided that produces an effect of reducing incident-angle dependency and has a wide reflection band.

The dielectric multilayer filter according to the present invention can be configured in such a manner that the average refractive index of the whole of the first dielectric multilayer film is set higher than the average refractive index of the whole of the second dielectric multilayer film. The term “average refractive index” used in this application refers to “(the total optical thickness of the dielectric multilayer film)×(the reference wavelength)/(the total physical thickness of the dielectric multilayer film)”.

The dielectric multilayer filter according to the present invention can be configured in such a manner that the first dielectric multilayer film has a structure including films of a first dielectric material having a predetermined refractive index and films of a second dielectric material having a refractive index higher than that of the first dielectric material that are alternately stacked, the second dielectric multilayer film has a structure including films of a third dielectric material having a predetermined refractive index and films of a fourth dielectric material having a refractive index higher than that of the third dielectric material that are alternately stacked, and the difference in refractive index between the first dielectric material and the second dielectric material is set smaller than the difference in refractive index between the third dielectric material and the fourth dielectric material.

The dielectric multilayer filter according to the present invention can be configured in such a manner that the first dielectric material has a refractive index of 1.60 to 2.10 for light having a wavelength of 550 nm, the second dielectric material has a refractive index of 2.0 or higher for light having a wavelength of 550 nm, the third dielectric material has a refractive index of 1.30 to 1.59 for light having a wavelength of 550 nm, and the fourth dielectric material has a refractive index of 2.0 or higher for light having a wavelength of 550 nm, for example.

The dielectric multilayer filter according to the present invention can be configured in such a manner that the second dielectric material is any of TiO₂ (refractive index≈2.2 to 2.5), Nb₂O₅ (refractive index≈2.1 to 2.4) and Ta₂O₅ (refractive index≈2.0 to 2.3) or a complex oxide (refractive index≈2.1 to 2.2) mainly containing any of TiO₂, Nb₂O₅ and Ta₂O₅, the third dielectric material is SiO₂ (refractive index≈1.46), and the fourth dielectric material is any of TiO₂, Nb₂O₅ and Ta₂O₅ or a complex oxide (refractive index≈2.0 or higher) mainly containing any of TiO₂, Nb₂O₅ and Ta₂O₅, for example.

The dielectric multilayer filter according to the present invention can be configured in such a manner that the first dielectric material is any of Bi₂O₃ (refractive index≈1.9), Ta₂O₅ (refractive index≈2.0), La₂O₃ (refractive index≈1.9), Al₂O₃ (refractive index≈1.62), SiOₓ (x≦1) (refractive index≈2.0), LaF₃, a complex oxide (refractive index≈1.7 to 1.8) of La₂O₃ and Al₂O₃ and a complex oxide (refractive index≈1.6 to 1.7) of Pr₂O₃ and Al₂O₃, or a complex oxide of two or more of these materials, for example.

The dielectric multilayer filter according to the present invention can be configured in such a manner that, in the first dielectric multilayer film, the optical thickness of the films of the second dielectric material is set greater than the optical thickness of the films of the first dielectric material. In this case, compared with the case where the optical thickness of the films of the first dielectric material is set equal to the optical thickness of the films of the second dielectric material, the average refractive index of the entire first dielectric multilayer film can be increased, so that the incident-angle dependency can be reduced. Here, the value of “(the optical thickness of the films of the second dielectric material)/(the optical thickness of the films of the first dielectric material)” can be greater than 1.0 and equal to or smaller than 4.0, for example.

The dielectric multilayer filter according to the present invention can be configured as an infrared cut filter that transmits visible light and reflects infrared light or a red-reflective dichroic filter that reflects red light, for example.

### BRIEF DESCRIPTION OF THE DRAWINGS

FIG. 1 is a schematic diagram showing a stack structure of a dielectric multilayer filter according to an embodiment of the present invention;

FIG. 2 is a schematic diagram showing a stack structure of an IR cut filter using a conventional dielectric multilayer filter;

FIG. 3 shows spectral transmittance characteristics of the IR cut filter shown in FIG. 2;

FIG. 4 is an enlarged view showing the spectral transmittance characteristics within a band of 600 to 700 nm in FIG. 3;

FIG. 5 is a diagram showing a stack structure of a dielectric multilayer filter described in the patent literature 1;

FIG. 6 shows spectral transmittance characteristics of the dielectric multilayer filter shown in FIG. 1;

FIG. 7 shows spectral transmittance characteristics according to a design of an example (1)-1;

FIG. 8 is an enlarged view showing the characteristics within a band of 620 to 690 nm in FIG. 7;

FIG. 9 shows spectral transmittance characteristics according to a design of an example (1)-2;

FIG. 10 is an enlarged view showing the characteristics within a band of 620 to 690 nm in FIG. 9;

FIG. 11 shows spectral transmittance characteristics according to a design of an example (1)-3;

FIG. 12 is an enlarged view showing the characteristics within a band of 620 to 690 nm in FIG. 11;

FIG. 13 shows spectral transmittance characteristics according to a design of an example (1)-4;

FIG. 14 is an enlarged view showing the characteristics within a band of 620 to 690 nm in FIG. 13;

FIG. 15 shows spectral transmittance characteristics according to a design of an example (1)-5;

FIG. 16 is an enlarged view showing the characteristics within a band of 620 to 690 nm in FIG. 15;

FIG. 17 shows spectral transmittance characteristics according to a design of an example (2)-1;

FIG. 18 shows spectral transmittance characteristics according to a design of an example (2)-2;

FIG. 19 shows spectral transmittance characteristics according to a design of an example (3)-1;

FIG. 20 is an enlarged view showing the characteristics within a band of 620 to 690 nm in FIG. 19;

FIG. 21 shows spectral transmittance characteristics according to a design of an example (3)-2;

FIG. 22 is an enlarged view showing the characteristics within a band of 620 to 690 nm in FIG. 21;

FIG. 23 shows spectral transmittance characteristics according to a design of an example (3)-3;

FIG. 24 is an enlarged view showing the characteristics within a band of 620 to 690 nm in FIG. 23;

FIG. 25 shows spectral transmittance characteristics according to a design of an example (3)-4;

FIG. 26 is an enlarged view showing the characteristics within a band of 620 to 690 nm in FIG. 25;

FIG. 27 shows spectral transmittance characteristics according to a design of an example (3)-5;

FIG. 28 is an enlarged view showing the characteristics within a band of 620 to 690 nm in FIG. 27;

FIG. 29 shows spectral transmittance characteristics according to a design of an example (3)-6;

FIG. 30 is an enlarged view showing the characteristics within a band of 620 to 690 nm in FIG. 29;

FIG. 31 shows spectral transmittance characteristics (simulation values) of the conventional red-reflective dichroic filter shown in FIG. 2;

FIG. 32 shows spectral transmittance characteristics (actual measurements) of an IR filter of a design according to an example (4) for an incident angle of 0 degrees;

FIG. 33 is an enlarged view showing spectral transmittance characteristics (actual measurements) of the IR filter of the design according to the example (4) within a band of 625 to 680 nm for varied incident angles;

FIG. 34 is an enlarged view showing spectral transmittance characteristics (simulation values) of an IR cut filter using a conventional dielectric multilayer film within a band of 625 to 680 nm for varied incident angles;

FIG. 35 shows spectral transmittance characteristics (simulation values) of a red-reflective dichroic filter of a design according to an example (5) for an incident angle of 45 degrees; and

FIG. 36 shows spectral transmittance characteristics (simulation values) of the red-reflective dichroic filter of the design according to the example (5) for varied incident angles.

### DETAILED DESCRIPTION OF THE PREFERRED EMBODIMENTS

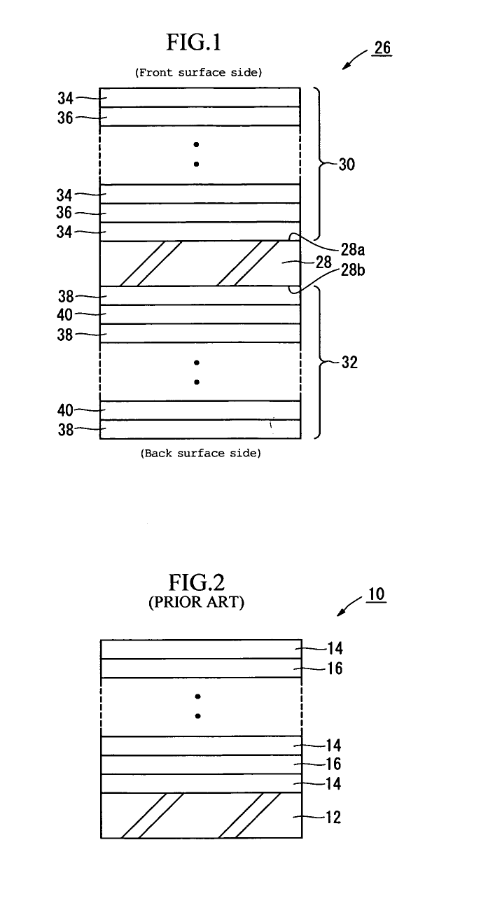

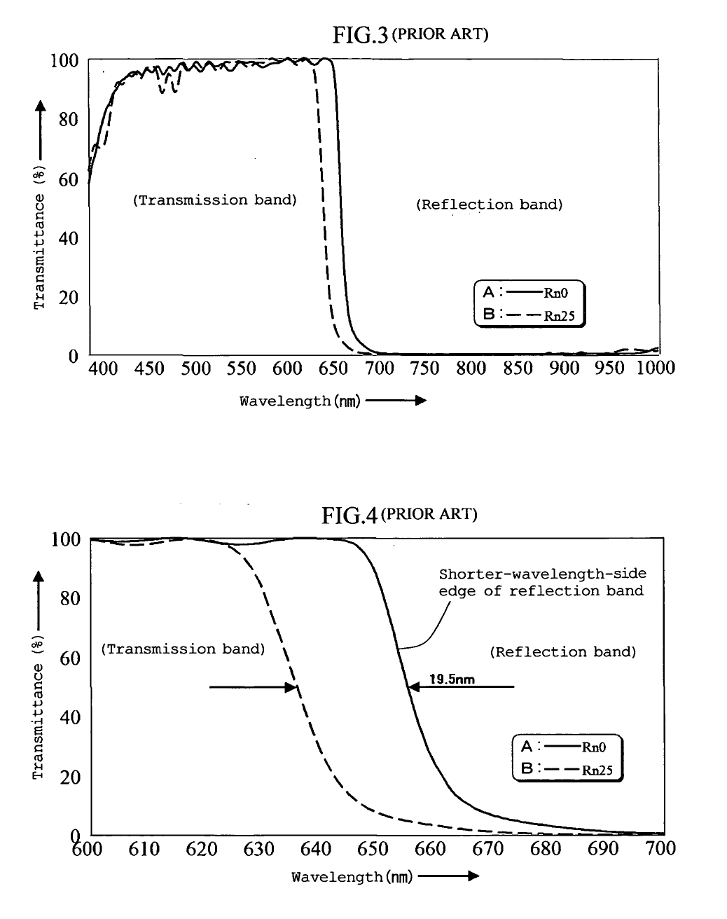

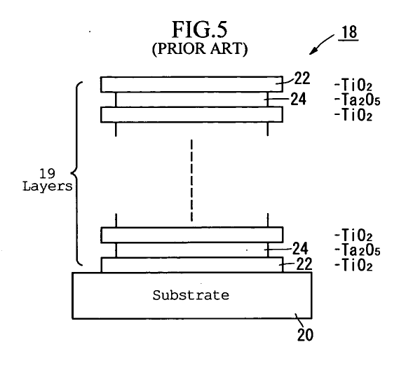

An embodiment of the present invention will be described below. FIG. 1 shows a dielectric multilayer filter according to the embodiment of the present invention. A dielectric multilayer filter 26 comprises a transparent substrate 28 of white glass or the like, a first dielectric multilayer film 30 deposited on a front surface (incidence plane of light) 28a of the transparent substrate 28, and a second dielectric multilayer film 32 deposited on a back surface 28b of the transparent substrate 28. The first dielectric multilayer film 30 is composed of films 34 of a first dielectric material having a predetermined refractive index and films 36 of a second dielectric material having a refractive index higher than that of the first dielectric material alternately stacked. The first dielectric multilayer film 30 is basically composed of an odd number of layers but may be composed of an even number of layers. Each layer 34, 36 basically has an optical thickness of λo/4 (λo: center wavelength of a reflection band). However, in order to achieve a desired characteristic, such as to reduce ripple, a first or last layer may have a thickness of λo/8, or the thickness of each layer may be fine-adjusted. Furthermore, although the film 34 having the lower refractive index is disposed as the first layer in FIG. 1, the film 36 having the higher refractive index may be disposed as the first layer.

The second dielectric multilayer film 32 is composed of films 38 of a third dielectric material having a refractive index lower than that of the first dielectric material and films 40 of a fourth dielectric material having a refractive index higher than that of the third dielectric material alternately stacked. The second dielectric multilayer film 32 is basically composed of an odd number of layers but may be composed of an even number of layers. Each layer 38, 40 basically has an optical thickness of λo/4 (λo: center wavelength of a reflection band). However, in order to achieve a desired characteristic, such as to reduce ripple, a first or last layer may have a thickness of λo/8, or the thickness of each layer may be fine-adjusted. Furthermore, although the film 38 having the lower refractive index is disposed as the first layer in FIG. 1, the film 40 having the higher refractive index may be disposed as the first layer.

The film 34 having the lower refractive index in the first dielectric multilayer film 30 may be made of a dielectric material (first dielectric material), which is any of Bi₂O₃, Ta₂O₅, La₂O₃, Al₂O₃, SiOₓ (x≦1), LaF₃, a complex oxide of La₂O₃ and Al₂O₃ and a complex oxide of Pr₂O₃ and Al₂O₃, or a complex oxide of two or more of these materials, for example. The film 36 having the higher refractive index in the first dielectric multilayer film 30 may be made of a dielectric material (second dielectric material), which is any of TiO₂, Nb₂O₅ and Ta₂O₅ or a complex oxide mainly containing any of TiO₂, Nb₂O₅ and Ta₂O₅, for example. The film 38 having the lower refractive index in the second dielectric multilayer film 32 may be made of a dielectric material (third dielectric material), such as SiO₂. The film 40 having the higher refractive index in the second dielectric multilayer film 32 may be made of a dielectric material (fourth dielectric material), which is any of TiO₂, Nb₂O₅ and Ta₂O₅ or a complex oxide mainly containing any of TiO₂, Nb₂O₅ and Ta₂O₅, for example.

The total (average) refractive index of the first dielectric multilayer film 30 is set higher than the total (average) refractive index of the second dielectric multilayer film 32. The difference in refractive index between the films 34 and 36 constituting the first dielectric multilayer film 30 is set smaller than the difference in refractive index between the films 38 and 40 constituting the second dielectric multilayer film 32. The second dielectric material forming the film 36 having the higher refractive index in the first dielectric multilayer film 30 may be the same as the fourth dielectric material forming the film 40 having the higher refractive index in the second dielectric multilayer film 32.

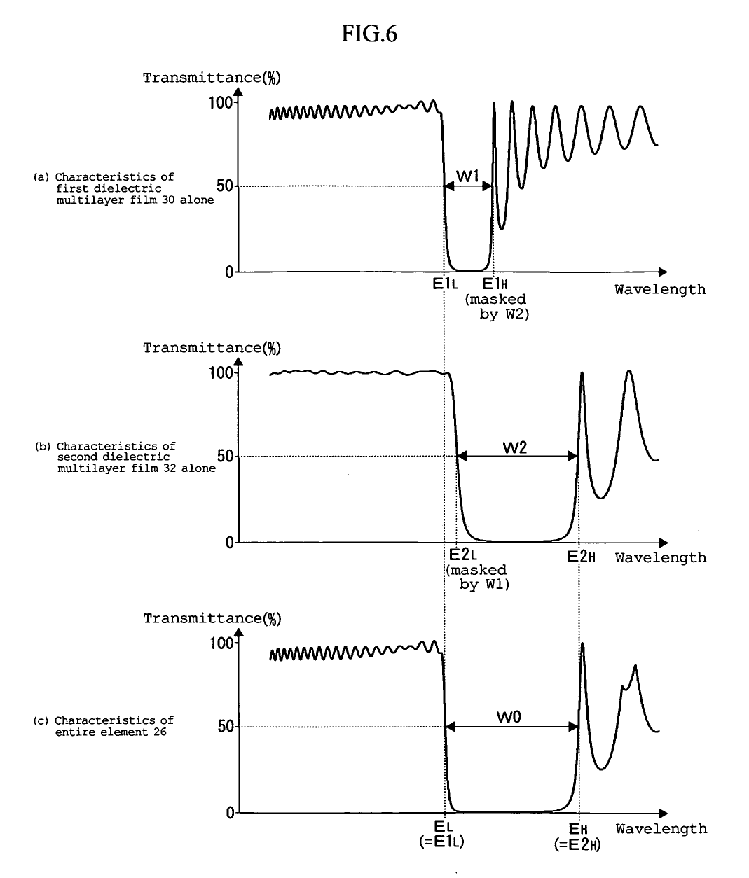

FIG. 6 shows spectral transmittance characteristics of the dielectric multilayer filter 26 shown in FIG. 1. In FIG. 6, FIG. 6(a) shows a characteristic of the first dielectric multilayer film 30 alone (in the absence of the second dielectric multilayer film 32), FIG. 6(b) shows a characteristics of the second dielectric multilayer film 32 alone (in the absence of the first dielectric multilayer film 30), and FIG. 6(c) shows a characteristics of the entire dielectric multilayer filter 26. The width W1 of the reflection band of the first dielectric multilayer film 30 is set narrower than the width W2 of the reflection band of the second dielectric multilayer film 32. The half-value wavelength E2_{L} at the shorter-wavelength-side edge of the reflection band of the second dielectric multilayer film 32 is set between the half-value wavelength E1_{L} at the shorter-wavelength-side edge and the half-value wavelength E1_{H} at the longer-wavelength-side edge of the reflection band of the first dielectric multilayer film 30. In other words, the half-value wavelength E1_{L} at the shorter-wavelength-side edge of the reflection band of the first dielectric multilayer film 30 is set shorter than the half-value wavelength E2_{L} at the shorter-wavelength-side edge of the reflection band of the second dielectric multilayer film 32, and the half-value wavelength E2_{H} at the longer-wavelength-side edge of the reflection band of the second dielectric multilayer film 32 is set longer than the half-value wavelength E1_{H} at the longer-wavelength-side edge of the reflection band of the first dielectric multilayer film 30.

As can be seen from FIG. 6, the width W0 of the reflection band of the entire element 26 is determined as the width between the half-value wavelength E1_{L} at the shorter-wavelength-side edge of the reflection band W1 of the first dielectric multilayer film 30 and the half-value wavelength E2_{H} at the longer-wavelength-side edge of the reflection band of the second dielectric multilayer film 32. Therefore, the width W1 of the reflection band of the first dielectric multilayer film 30 has no effect on the width W0 of the reflection band of the entire element 26 (in other words, the width W0 can be set independently of the width W1), so that the width W1 of the reflection band of the first dielectric multilayer film 30 can be set narrow. As a result, the shift of the half-value wavelength E_{L} at the shorter-wavelength-side edge of the reflection band of the entire element 26 (a wavelength close to 650 nm in the case of an IR cut filter or a wavelength close to 600 nm in the case of a red-reflective dichroic filter), which is determined as the half-value wavelength E1_{L} at the shorter-wavelength-side edge of the reflection band of the first dielectric multilayer film 30, due to variations in incident angle is reduced, and the incident-angle dependency of the entire element 26 can be reduced. On the other hand, the half-value wavelength E2_{L} at the shorter-wavelength-side edge of the reflection band of the second dielectric multilayer film 32 is masked by the reflection band W1 of the first dielectric multilayer film 30, and thus, the incident-angle dependency of the half-value wavelength E2_{L} at the shorter-wavelength-side edge of the reflection band of the second dielectric multilayer film 32 has no effect on the reflection characteristics of the entire element 26. Thus, the width W2 of the reflection band of the second dielectric multilayer film 32 can be set wide, and as a result, it can be ensured that the reflection band of the entire element 26 has a large width W0. In this way, the dielectric multilayer filter 26 shown in FIG. 1 can have a reduced incident-angle dependency and a wide reflection band.

### EXAMPLES

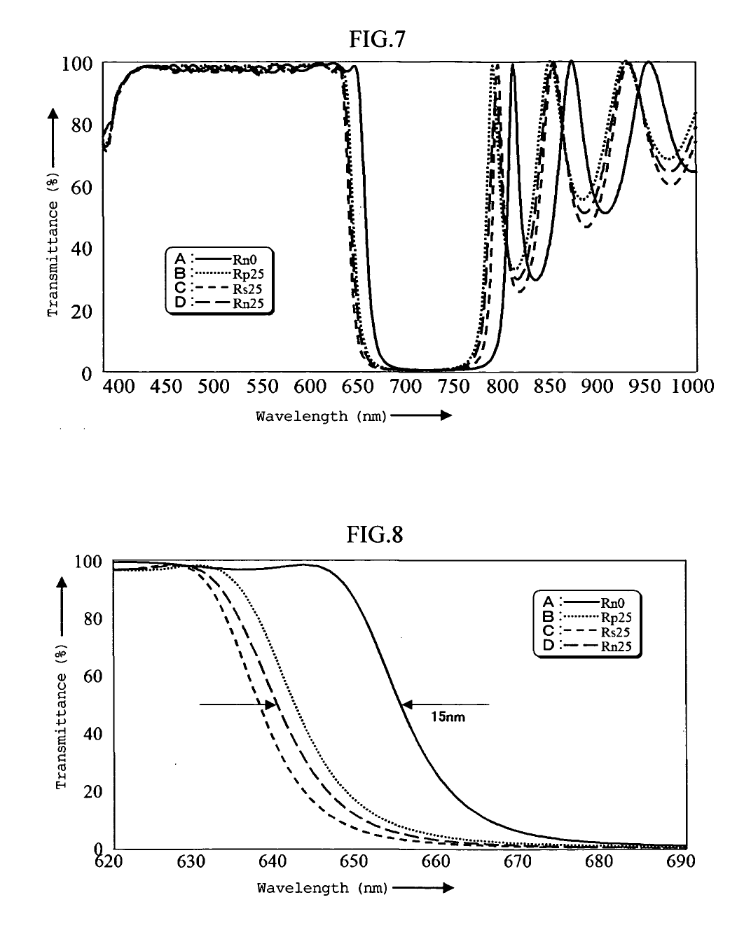

Examples (1) to (4) in which the dielectric multilayer filter 26 shown in FIG. 1 is configured as an IR cut filter and an example (5) in which the dielectric multilayer filter 26 is configured as a red-reflective dichroic filter will be described. In FIGS. 7 to 30 showing spectral transmittance characteristics for the examples (1) to (3) (all of which are determined by simulation), characteristics A to D represent the transmittances described below. The values of the refractive index and the attenuation coefficient for the design in each example are those with respect to a design wavelength (reference wavelength) λo in the example.

Characteristic A: transmittance for an incident angle of 0 degrees

Characteristic B: transmittance of p-polarized light for an incident angle of 25 degrees

Characteristic C: transmittance of s-polarized light for an incident angle of 25 degrees

Characteristic D: average transmittance of p-polarized light and s-polarized light (n-polarized light) for an incident angle of 25 degrees

(1) Examples of First Dielectric Multilayer Film 30

Examples of the first dielectric multilayer film 30 will be described. In the following examples, the first dielectric multilayer film 30 was designed so that the half-value wavelength E1_{L} at the shorter-wavelength-side edge of the reflection band (see FIG. 6(a)) is 655 nm when the incident angle is 0 degrees.

### Example (1)-1

The first dielectric multilayer film 30 was designed using the following parameters.

Substrate: glass (having a refractive index of 1.51 and an attenuation coefficient of 0)

Film 34: complex oxide of La₂O₃ and Al₂O₃ (having a refractive index of 1.72 and an attenuation coefficient of 0)

Film 36: TiO₂ (having a refractive index of 2.27 and an attenuation coefficient of 0.0000817)

Number of layers: 27

Reference wavelength (center wavelength of the reflection band) λo: 731.5 nm

The thickness of each layer is shown in Table 1.

TABLE 1

| | | |
|---|---|---|
| | | Optical |
| Layer No. | Material | thickness (nd) |

(Substrate)

| | | |
|---|---|---|
| 1 | La₂O₃ + Al₂O₃ | 0.147 λ₀ |
| 2 | TiO₂ | 0.271 λ₀ |
| 3 | La₂O₃ + Al₂O₃ | 0.285 λ₀ |
| 4 | TiO₂ | 0.246 λ₀ |
| 5 | La₂O₃ + Al₂O₃ | 0.267 λ₀ |
| 6 | TiO₂ | 0.24 λ₀ |
| 7 | La₂O₃ + Al₂O₃ | 0.256 λ₀ |
| 8 | TiO₂ | 0.235 λ₀ |
| 9 | La₂O₃ + Al₂O₃ | 0.256 λ₀ |
| 10 | TiO₂ | 0.235 λ₀ |
| 11 | La₂O₃ + Al₂O₃ | 0.256 λ₀ |
| 12 | TiO₂ | 0.235 λ₀ |
| 13 | La₂O₃ + Al₂O₃ | 0.256 λ₀ |
| 14 | TiO₂ | 0.234 λ₀ |
| 15 | La₂O₃ + Al₂O₃ | 0.254 λ₀ |
| 16 | TiO₂ | 0.234 λ₀ |
| 17 | La₂O₃ + Al₂O₃ | 0.254 λ₀ |
| 18 | TiO₂ | 0.234 λ₀ |
| 19 | La₂O₃ + Al₂O₃ | 0.254 λ₀ |
| 20 | TiO₂ | 0.234 λ₀ |
| 21 | La₂O₃ + Al₂O₃ | 0.252 λ₀ |
| 22 | TiO₂ | 0.24 λ₀ |
| 23 | La₂O₃ + Al₂O₃ | 0.252 λ₀ |
| 24 | TiO₂ | 0.24 λ₀ |
| 25 | La₂O₃ + Al₂O₃ | 0.281 λ₀ |
| 26 | TiO₂ | 0.179 λ₀ |
| 27 | La₂O₃ + Al₂O₃ | 0.131 λ₀ |

(Air layer)
λ₀ = 731.5 nm

FIG. 7 shows spectral transmittance characteristics (characteristics of the film alone) according to the design of the example (1)-1. FIG. 8 is an enlarged view showing the spectral transmittance characteristics within a band of 620 to 690 nm in FIG. 7. According to this design, the following characteristics were obtained. In the description of the characteristics, the term “high-reflectance band (bandwidth)” refers to a band (bandwidth) in which the transmittance is equal to or less than 1% (the same holds true for the other examples).

High-reflectance band for an incident-angle of 0 degrees: 686.8 to 770.7 nm

High-reflectance bandwidth for an incident-angle of 0 degrees: 83.9 nm

High-reflectance band of p-polarized light for an incident-angle of 25 degrees: 676.5 to 746 nm

High-reflectance bandwidth of p-polarized light for an incident-angle of 25 degrees: 69.5 nm

High-reflectance band of s-polarized light for an incident-angle of 25 degrees: 666 to 759.8 nm

High-reflectance bandwidth of s-polarized light for an incident-angle of 25 degrees: 93.8 nm

Shift of the half-value wavelength E1_{L} at the shorter-wavelength-side edge of the reflection band between the case where the incident angle is 0 degrees (characteristic A) and the case where the incident angle is 25 degrees (characteristic D): 15 nm (see FIG. 8)

Average refractive index of the entire stack film: 1.94

### Example (1)-2

The first dielectric multilayer film 30 was designed using the following parameters.

Substrate: glass (having a refractive index of 1.51 and an attenuation coefficient of 0)

Film 34: complex oxide of La₂O₃ and Al₂O₃ (having a refractive index of 1.72 and an attenuation coefficient of 0)

Film 36: Nb₂O₅ (having a refractive index of 2.32 and an attenuation coefficient of 0)

Number of layers: 27

Reference wavelength (center wavelength of the reflection band) λo: 732 nm

The thickness of each layer is shown in Table 2.

TABLE 2

| | | |
|---|---|---|
| | | Optical |
| Layer No. | Material | thickness (nd) |

(Substrate)

| | | |
|---|---|---|
| 1 | La₂O₃ + Al₂O₃ | 0.147 λ₀ |
| 2 | Nb₂O₅ | 0.277 λ₀ |
| 3 | La₂O₃ + Al₂O₃ | 0.285 λ₀ |
| 4 | Nb₂O₅ | 0.25 λ₀ |
| 5 | La₂O₃ + Al₂O₃ | 0.267 λ₀ |
| 6 | Nb₂O₅ | 0.245 λ₀ |
| 7 | La₂O₃ + Al₂O₃ | 0.256 λ₀ |
| 8 | Nb₂O₅ | 0.238 λ₀ |
| 9 | La₂O₃ + Al₂O₃ | 0.256 λ₀ |
| 10 | Nb₂O₅ | 0.238 λ₀ |
| 11 | La₂O₃ + Al₂O₃ | 0.256 λ₀ |
| 12 | Nb₂O₅ | 0.238 λ₀ |
| 13 | La₂O₃ + Al₂O₃ | 0.256 λ₀ |
| 14 | Nb₂O₅ | 0.236 λ₀ |
| 15 | La₂O₃ + Al₂O₃ | 0.253 λ₀ |
| 16 | Nb₂O₅ | 0.236 λ₀ |
| 17 | La₂O₃ + Al₂O₃ | 0.253 λ₀ |
| 18 | Nb₂O₅ | 0.236 λ₀ |
| 19 | La₂O₃ + Al₂O₃ | 0.253 λ₀ |
| 20 | Nb₂O₅ | 0.236 λ₀ |
| 21 | La₂O₃ + Al₂O₃ | 0.253 λ₀ |
| 22 | Nb₂O₅ | 0.243 λ₀ |
| 23 | La₂O₃ + Al₂O₃ | 0.253 λ₀ |
| 24 | Nb₂O₅ | 0.243 λ₀ |
| 25 | La₂O₃ + Al₂O₃ | 0.277 λ₀ |
| 26 | Nb₂O₅ | 0.184 λ₀ |
| 27 | La₂O₃ + Al₂O₃ | 0.138 λ₀ |

(Air layer)
λ₀ = 732 nm

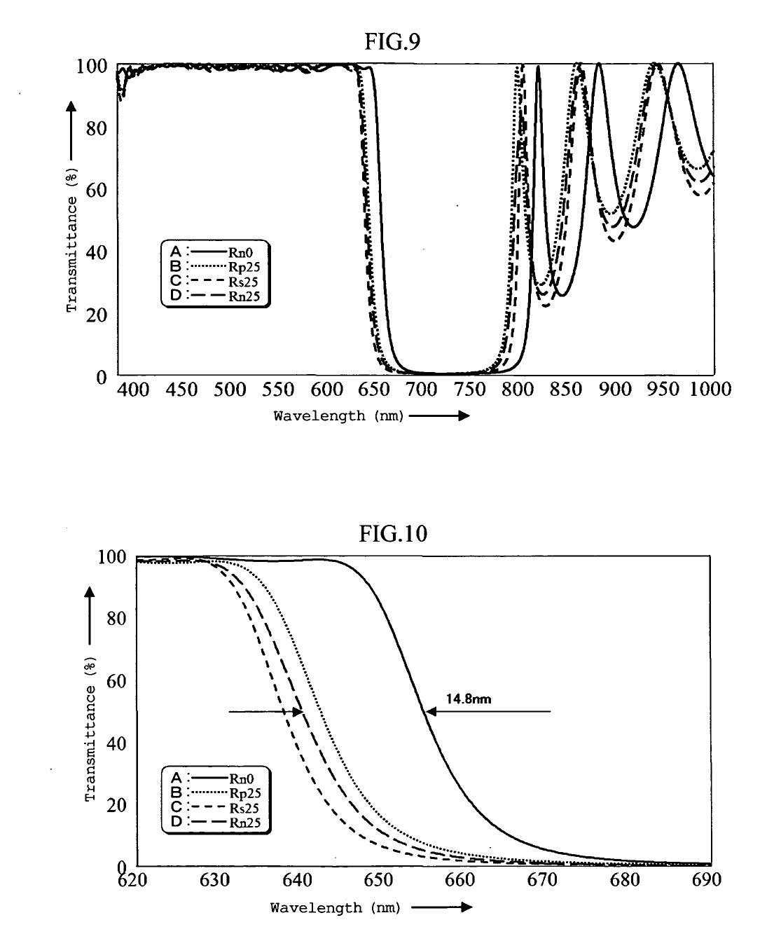

FIG. 9 shows spectral transmittance characteristics (characteristics of the film alone) according to the design of the example (1)-2. FIG. 10 is an enlarged view showing the spectral transmittance characteristics within a band of 620 to 690 nm FIG. 9. According to this design, the following characteristics were obtained.

High-reflectance band for an incident-angle of 0 degrees: 684.9 to 784.4 nm

High-reflectance bandwidth for an incident-angle of 0 degrees: 99.5 nm

High-reflectance band of p-polarized light for an incident-angle of 25 degrees: 674.1 to 759.7 nm

High-reflectance bandwidth of p-polarized light for an incident-angle of 25 degrees: 85.6 nm

High-reflectance band of s-polarized light for an incident-angle of 25 degrees: 664.5 to 772.5 nm

High-reflectance bandwidth of s-polarized light for an incident-angle of 25 degrees: 108 nm

Shift of the half-value wavelength E1_{L} at the shorter-wavelength-side edge of the reflection band between the case where the incident angle is 0 degrees (characteristic A) and the case where the incident angle is 25 degrees (characteristic D): 14.8 nm (see FIG. 10)

Average refractive index of the entire stack film: 1.96

According to this design, since Nb₂O₅ forming the film 36 has a slightly higher refractive index than TiO₂ forming the film 36 in the example (1)-1, the shift is reduced by 0.2 nm compared with the example (1)-1.

### Example (1)-3

The first dielectric multilayer film 30 was designed using the following parameters.

Substrate: glass (having a refractive index of 1.51 and an attenuation coefficient of 0)

Film 34: complex oxide of La₂O₃ and Al₂O₃ (having a refractive index of 1.81 and an attenuation coefficient of 0)

Film 36: TiO₂ (having a refractive index of 2.27 and an attenuation coefficient of 0.0000821)

Number of layers: 31

Reference wavelength (center wavelength of the reflection band) λo: 729.5 nm

The thickness of each layer is shown in Table 3.

TABLE 3

| | | |
|---|---|---|
| | | Optical |
| Layer No. | Material | thickness (nd) |

(Substrate)

| | | |
|---|---|---|
| 1 | La₂O₃ + Al₂O₃ | 0.138 λ₀ |
| 2 | TiO₂ | 0.255 λ₀ |
| 3 | La₂O₃ + Al₂O₃ | 0.273 λ₀ |
| 4 | TiO₂ | 0.249 λ₀ |
| 5 | La₂O₃ + Al₂O₃ | 0.259 λ₀ |
| 6 | TiO₂ | 0.24 λ₀ |
| 7 | La₂O₃ + Al₂O₃ | 0.254 λ₀ |
| 8 | TiO₂ | 0.231 λ₀ |
| 9 | La₂O₃ + Al₂O₃ | 0.254 λ₀ |
| 10 | TiO₂ | 0.231 λ₀ |
| 11 | La₂O₃ + Al₂O₃ | 0.254 λ₀ |
| 12 | TiO₂ | 0.231 λ₀ |
| 13 | La₂O₃ + Al₂O₃ | 0.254 λ₀ |
| 14 | TiO₂ | 0.231 λ₀ |
| 15 | La₂O₃ + Al₂O₃ | 0.254 λ₀ |
| 16 | TiO₂ | 0.229 λ₀ |
| 17 | La₂O₃ + Al₂O₃ | 0.253 λ₀ |
| 18 | TiO₂ | 0.229 λ₀ |
| 19 | La₂O₃ + Al₂O₃ | 0.253 λ₀ |
| 20 | TiO₂ | 0.229 λ₀ |
| 21 | La₂O₃ + Al₂O₃ | 0.253 λ₀ |
| 22 | TiO₂ | 0.229 λ₀ |
| 23 | La₂O₃ + Al₂O₃ | 0.253 λ₀ |
| 24 | TiO₂ | 0.229 λ₀ |
| 25 | La₂O₃ + Al₂O₃ | 0.255 λ₀ |
| 26 | TiO₂ | 0.23 λ₀ |
| 27 | La₂O₃ + Al₂O₃ | 0.255 λ₀ |
| 28 | TiO₂ | 0.23 λ₀ |
| 29 | La₂O₃ + Al₂O₃ | 0.288 λ₀ |
| 30 | TiO₂ | 0.137 λ₀ |
| 31 | La₂O₃ + Al₂O₃ | 0.146 λ₀ |

(Air layer)
λ₀ = 729.5 nm

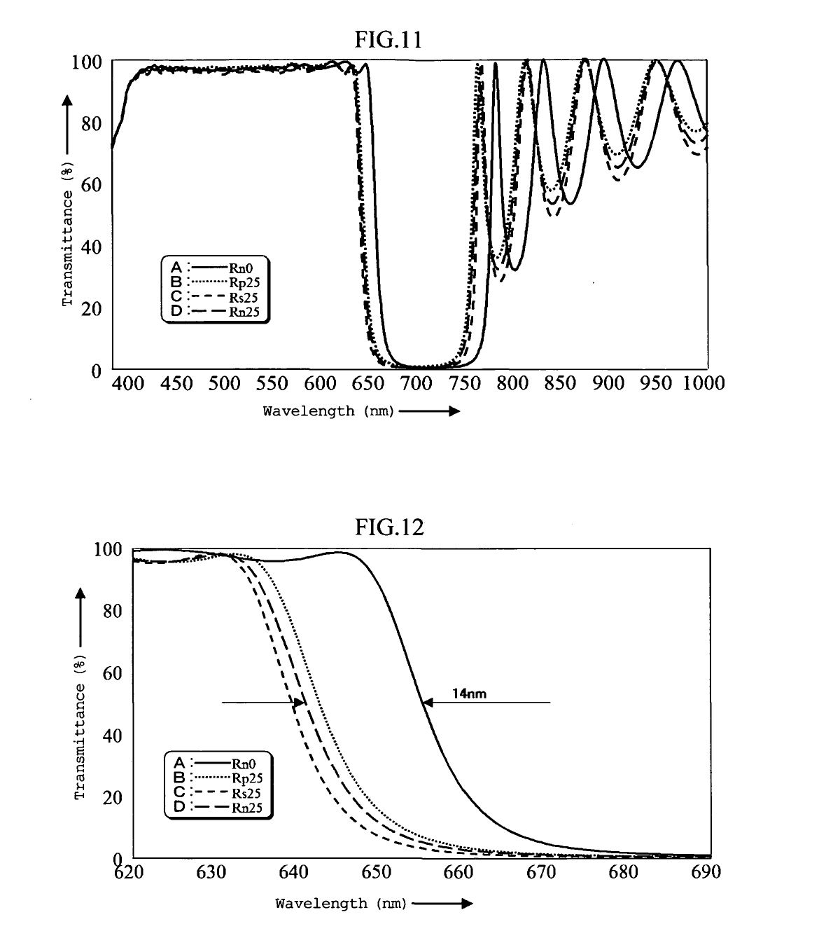

FIG. 11 shows spectral transmittance characteristics (characteristics of the film alone) according to the design of the example (1)-3. FIG. 12 is an enlarged view showing the spectral transmittance characteristics within a band of 620 to 690 nm in FIG. 11. According to this design, the following characteristics were obtained.

High-reflectance band for an incident-angle of 0 degrees: 685.5 to 744.5 nm

High-reflectance bandwidth for an incident-angle of 0 degrees: 59 nm

High-reflectance band of p-polarized light for an incident-angle of 25 degrees: 675.6 to 722.7 nm

High-reflectance bandwidth of p-polarized light for an incident-angle of 25 degrees: 47.1 nm

High-reflectance band of s-polarized light for an incident-angle of 25 degrees: 655.9 to 734.5 nm

High-reflectance bandwidth of s-polarized light for an incident-angle of 25 degrees: 78.6 nm

Shift of the half-value wavelength E1_{L} at the shorter-wavelength-side edge of the reflection band between the case where the incident angle is 0 degrees (characteristic A) and the case where the incident angle is 25 degrees (characteristic D): 14 nm (see FIG. 12)

Average refractive index of the entire stack film: 2.00

According to this design, the shift is reduced by 0.8 nm compared with the example (1)-2.

### Example (1)-4

The first dielectric multilayer film 30 was designed using the following parameters.

Substrate: glass (having a refractive index of 1.51 and an attenuation coefficient of 0)

Film 34: Bi₂O₃ (having a refractive index of 1.91 and an attenuation coefficient of 0)

Film 36: TiO₂ (having a refractive index of 2.28 and an attenuation coefficient of 0.0000879)

Number of layers: 41

Reference wavelength (center wavelength of the reflection band) λo: 700.5 nm

The thickness of each layer is shown in Table 4.

TABLE 4

| | | |
|---|---|---|
| | | Optical |
| Layer No. | Material | thickness (nd) |

(Substrate)

| | | |
|---|---|---|
| 1 | Bi₂O₃ | 0.138 λ₀ |
| 2 | TiO₂ | 0.229 λ₀ |
| 3 | Bi₂O₃ | 0.28 λ₀ |
| 4 | TiO₂ | 0.239 λ₀ |
| 5 | Bi₂O₃ | 0.276 λ₀ |
| 6 | TiO₂ | 0.233 λ₀ |
| 7 | Bi₂O₃ | 0.276 λ₀ |
| 8 | TiO₂ | 0.227 λ₀ |
| 9 | Bi₂O₃ | 0.276 λ₀ |
| 10 | TiO₂ | 0.227 λ₀ |
| 11 | Bi₂O₃ | 0.276 λ₀ |
| 12 | TiO₂ | 0.217 λ₀ |
| 13 | Bi₂O₃ | 0.279 λ₀ |
| 14 | TiO₂ | 0.218 λ₀ |
| 15 | Bi₂O₃ | 0.279 λ₀ |
| 16 | TiO₂ | 0.218 λ₀ |
| 17 | Bi₂O₃ | 0.279 λ₀ |
| 18 | TiO₂ | 0.21 λ₀ |
| 19 | Bi₂O₃ | 0.286 λ₀ |
| 20 | TiO₂ | 0.21 λ₀ |
| 21 | Bi₂O₃ | 0.286 λ₀ |
| 22 | TiO₂ | 0.21 λ₀ |
| 23 | Bi₂O₃ | 0.286 λ₀ |
| 24 | TiO₂ | 0.21 λ₀ |
| 25 | Bi₂O₃ | 0.286 λ₀ |
| 26 | TiO₂ | 0.21 λ₀ |
| 27 | Bi₂O₃ | 0.286 λ₀ |
| 28 | TiO₂ | 0.21 λ₀ |
| 29 | Bi₂O₃ | 0.286 λ₀ |
| 30 | TiO₂ | 0.21 λ₀ |
| 31 | Bi₂O₃ | 0.286 λ₀ |
| 32 | TiO₂ | 0.21 λ₀ |
| 33 | Bi₂O₃ | 0.286 λ₀ |
| 34 | TiO₂ | 0.21 λ₀ |
| 35 | Bi₂O₃ | 0.286 λ₀ |
| 36 | TiO₂ | 0.21 λ₀ |
| 37 | Bi₂O₃ | 0.33 λ₀ |
| 38 | TiO₂ | 0.108 λ₀ |
| 39 | Bi₂O₃ | 0.349 λ₀ |
| 40 | TiO₂ | 0.153 λ₀ |
| 41 | Bi₂O₃ | 0.164 λ₀ |

(Air layer)
λ₀ = 700.5 nm

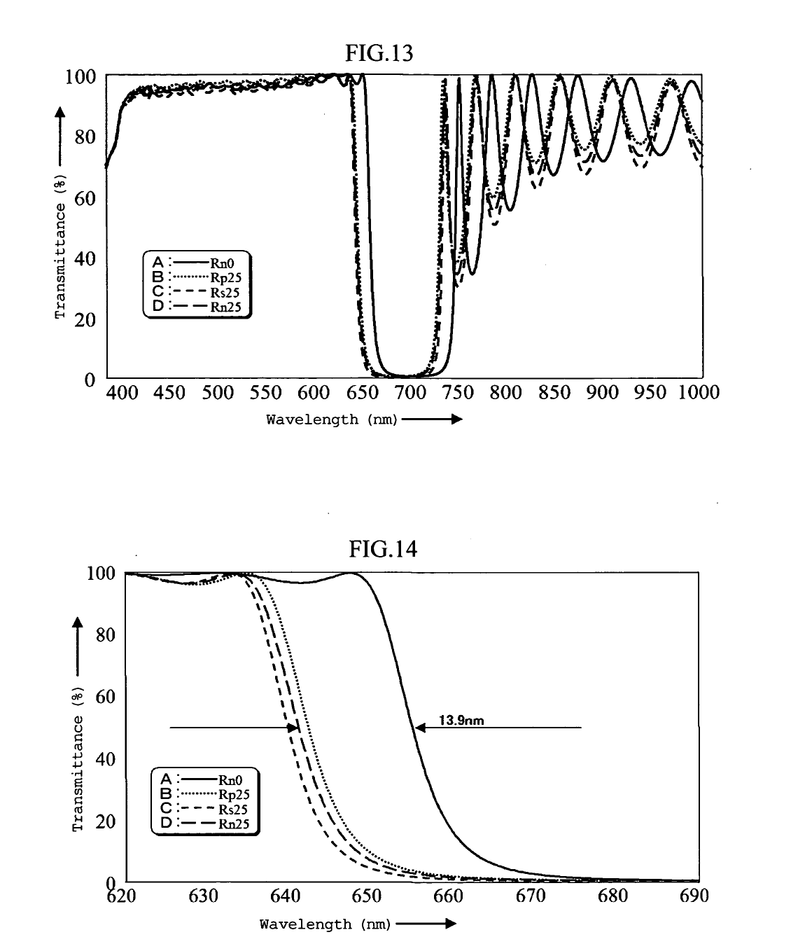

FIG. 13 shows spectral transmittance characteristics (characteristics of the film alone) according to the design of the example (1)-4. FIG. 14 is an enlarged view showing the spectral transmittance characteristics within a band of 620 to 690 nm in FIG. 13. According to this design, the following characteristics were obtained.

High-reflectance band for an incident-angle of 0 degrees: 677.5 to 723.5 nm

High-reflectance bandwidth for an incident-angle of 0 degrees: 46 nm

High-reflectance band of p-polarized light for an incident-angle of 25 degrees: 656 to 705 nm

High-reflectance bandwidth of p-polarized light for an incident-angle of 25 degrees: 49 nm

High-reflectance band of s-polarized light for an incident-angle of 25 degrees: 659.3 to 713 nm

High-reflectance bandwidth of s-polarized light for an incident-angle of 25 degrees: 53.7 nm

Shift of the half-value wavelength E1_{L} at the shorter-wavelength-side edge of the reflection band between the case where the incident angle is 0 degrees (characteristic A) and the case where the incident angle is 25 degrees (characteristic D): 13.9 nm (see FIG. 14)

Average refractive index of the entire stack film: 2.05

According to this design, since Bi₂O₃ forming the film 34 has a slightly higher refractive index than the complex oxide of La₂O₃ and Al₂O₃ forming the film 34 in the example (1)-3, the shift is reduced by 0.1 nm compared with the example (1)-3.

### Example (1)-5

The first dielectric multilayer film 30 was designed using the following parameters.

Substrate: glass (having a refractive index of 1.51 and an attenuation coefficient of 0)

Film 34: Ta₂O₅ (having a refractive index of 2.04 and an attenuation coefficient of 0)

Film 36: Nb₂O₅ (having a refractive index of 2.32 and an attenuation coefficient of 0)

Number of layers: 55

Reference wavelength (center wavelength of the reflection band) λo: 691.5 nm

The thickness of each layer is shown in Table 5.

TABLE 5

| | | |
|---|---|---|
| | | Optical |
| Layer No. | Material | thickness (nd) |

(Substrate)

| | | |
|---|---|---|
| 1 | Ta₂O₅ | 0.158 λ₀ |
| 2 | Nb₂O₅ | 0.156 λ₀ |
| 3 | Ta₂O₅ | 0.292 λ₀ |
| 4 | Nb₂O₅ | 0.241 λ₀ |
| 5 | Ta₂O₅ | 0.26 λ₀ |
| 6 | Nb₂O₅ | 0.241 λ₀ |
| 7 | Ta₂O₅ | 0.26 λ₀ |
| 8 | Nb₂O₅ | 0.241 λ₀ |
| 9 | Ta₂O₅ | 0.26 λ₀ |
| 10 | Nb₂O₅ | 0.241 λ₀ |
| 11 | Ta₂O₅ | 0.26 λ₀ |
| 12 | Nb₂O₅ | 0.241 λ₀ |
| 13 | Ta₂O₅ | 0.26 λ₀ |
| 14 | Nb₂O₅ | 0.241 λ₀ |
| 15 | Ta₂O₅ | 0.26 λ₀ |
| 16 | Nb₂O₅ | 0.241 λ₀ |
| 17 | Ta₂O₅ | 0.26 λ₀ |
| 18 | Nb₂O₅ | 0.236 λ₀ |
| 19 | Ta₂O₅ | 0.257 λ₀ |
| 20 | Nb₂O₅ | 0.245 λ₀ |
| 21 | Ta₂O₅ | 0.247 λ₀ |
| 22 | Nb₂O₅ | 0.245 λ₀ |
| 23 | Ta₂O₅ | 0.247 λ₀ |
| 24 | Nb₂O₅ | 0.245 λ₀ |
| 25 | Ta₂O₅ | 0.247 λ₀ |
| 26 | Nb₂O₅ | 0.245 λ₀ |
| 27 | Ta₂O₅ | 0.247 λ₀ |
| 28 | Nb₂O₅ | 0.245 λ₀ |
| 29 | Ta₂O₅ | 0.247 λ₀ |
| 30 | Nb₂O₅ | 0.245 λ₀ |
| 31 | Ta₂O₅ | 0.247 λ₀ |
| 32 | Nb₂O₅ | 0.245 λ₀ |
| 33 | Ta₂O₅ | 0.247 λ₀ |
| 34 | Nb₂O₅ | 0.245 λ₀ |
| 35 | Ta₂O₅ | 0.247 λ₀ |
| 36 | Nb₂O₅ | 0.245 λ₀ |
| 37 | Ta₂O₅ | 0.247 λ₀ |
| 38 | Nb₂O₅ | 0.245 λ₀ |
| 39 | Ta₂O₅ | 0.247 λ₀ |
| 40 | Nb₂O₅ | 0.245 λ₀ |
| 41 | Ta₂O₅ | 0.247 λ₀ |
| 42 | Nb₂O₅ | 0.245 λ₀ |
| 43 | Ta₂O₅ | 0.247 λ₀ |
| 44 | Nb₂O₅ | 0.245 λ₀ |
| 45 | Ta₂O₅ | 0.248 λ₀ |
| 46 | Nb₂O₅ | 0.245 λ₀ |
| 47 | Ta₂O₅ | 0.248 λ₀ |
| 48 | Nb₂O₅ | 0.245 λ₀ |
| 49 | Ta₂O₅ | 0.248 λ₀ |
| 50 | Nb₂O₅ | 0.245 λ₀ |
| 51 | Ta₂O₅ | 0.248 λ₀ |
| 52 | Nb₂O₅ | 0.253 λ₀ |
| 53 | Ta₂O₅ | 0.259 λ₀ |
| 54 | Nb₂O₅ | 0.16 λ₀ |
| 55 | Ta₂O₅ | 0.16 λ₀ |

(Air layer)
λ₀ = 691.5 nm

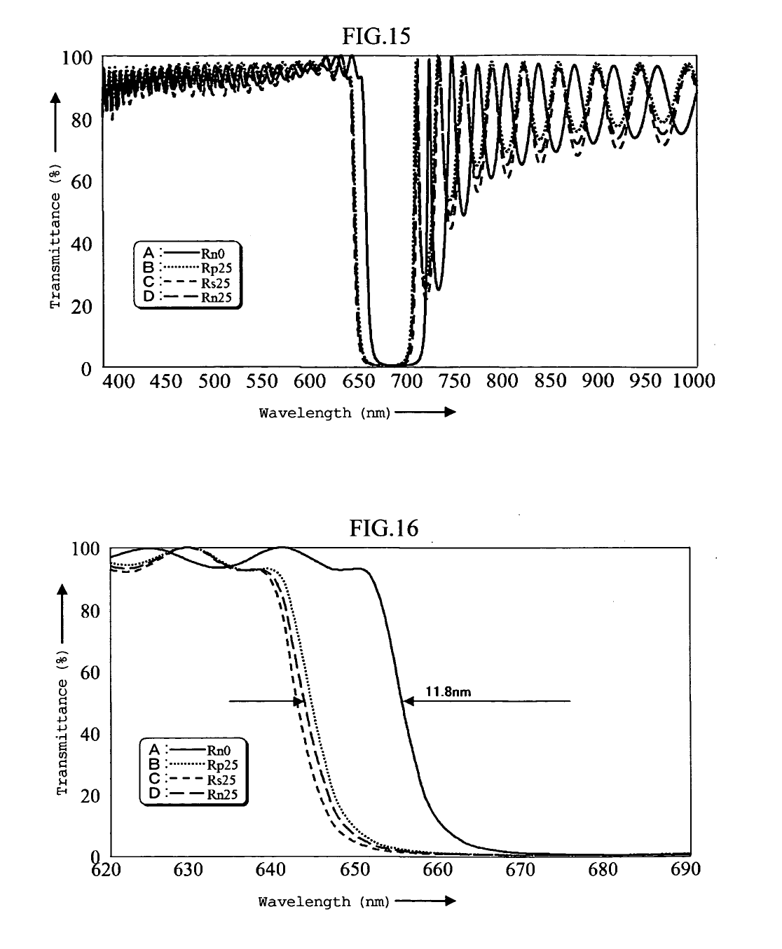

FIG. 15 shows spectral transmittance characteristics (characteristics of the film alone) according to the design of the example (1)-5. FIG. 16 is an enlarged view showing the spectral transmittance characteristics within a band of 620 to 690 nm in FIG. 15. According to this design, the following characteristics were obtained.

High-reflectance band for an incident-angle of 0 degrees: 669.5 to 706.8 nm

High-reflectance bandwidth for an incident-angle of 0 degrees: 37.3 nm

High-reflectance band of p-polarized light for an incident-angle of 25 degrees: 659.5 to 691.6 nm

High-reflectance bandwidth of p-polarized light for an incident-angle of 25 degrees: 32.1 nm

High-reflectance band of s-polarized light for an incident-angle of 25 degrees: 655.7 to 696.3 nm

High-reflectance bandwidth of s-polarized light for an incident-angle of 25 degrees: 40.6 nm

Shift of the half-value wavelength E1_{L} at the shorter-wavelength-side edge of the reflection band between the case where the incident angle is 0 degrees (characteristic A) and the case where the incident angle is 25 degrees (characteristic D): 11.8 nm (see FIG. 16)

Average refractive index of the entire stack film: 2.17

According to this design, the shift is reduced by 2.1 nm compared with the example (1)-4.

(2) Examples of Second Dielectric Multilayer Film 32

Examples of the second dielectric multilayer film 32 will be described. In the following examples, the second dielectric multilayer film 32 was designed so that the half-value wavelength E2_{L} at the shorter-wavelength-side edge of the reflection band (see FIG. 6(b)) is 670 nm when the incident angle is 0 degrees. In other words, the half-value wavelength E2_{L} was set 20 nm longer than the half-value wavelength E1_{L} at the shorter-wavelength-side edge of the reflection band of the first dielectric multilayer film 30 according to the examples (1)-1 to (1)-5 (it is supposed that E1_{L}=650 nm here).

### Example (2)-1

The second dielectric multilayer film 32 was designed using the following parameters.

Substrate: glass (having a refractive index of 1.51 and an attenuation coefficient of 0)

Film 38: SiO₂ (having a refractive index of 1.45 and an attenuation coefficient of 0)

Film 40: TiO₂ (having a refractive index of 2.25 and an attenuation coefficient of 0.0000696)

Number of layers: 37

Reference wavelength (center wavelength of the reflection band) λo: 847 nm

The thickness of each layer is shown in Table 6.

TABLE 6

| | | |
|---|---|---|
| | | Optical |
| Layer No. | Material | thickness (nd) |

(Substrate)

| | | |
|---|---|---|
| 1 | SiO₂ | 0.1 λ₀ |
| 2 | TiO₂ | 0.236 λ₀ |
| 3 | SiO₂ | 0.265 λ₀ |
| 4 | TiO₂ | 0.229 λ₀ |
| 5 | SiO₂ | 0.239 λ₀ |
| 6 | TiO₂ | 0.219 λ₀ |
| 7 | SiO₂ | 0.237 λ₀ |
| 8 | TiO₂ | 0.213 λ₀ |
| 9 | SiO₂ | 0.237 λ₀ |
| 10 | TiO₂ | 0.213 λ₀ |
| 11 | SiO₂ | 0.237 λ₀ |
| 12 | TiO₂ | 0.213 λ₀ |
| 13 | SiO₂ | 0.237 λ₀ |
| 14 | TiO₂ | 0.213 λ₀ |
| 15 | SiO₂ | 0.237 λ₀ |
| 16 | TiO₂ | 0.225 λ₀ |
| 17 | SiO₂ | 0.248 λ₀ |
| 18 | TiO₂ | 0.235 λ₀ |
| 19 | SiO₂ | 0.268 λ₀ |
| 20 | TiO₂ | 0.258 λ₀ |
| 21 | SiO₂ | 0.28 λ₀ |
| 22 | TiO₂ | 0.263 λ₀ |
| 23 | SiO₂ | 0.283 λ₀ |
| 24 | TiO₂ | 0.263 λ₀ |
| 25 | SiO₂ | 0.283 λ₀ |
| 26 | TiO₂ | 0.263 λ₀ |
| 27 | SiO₂ | 0.283 λ₀ |
| 28 | TiO₂ | 0.263 λ₀ |
| 29 | SiO₂ | 0.283 λ₀ |
| 30 | TiO₂ | 0.263 λ₀ |
| 31 | SiO₂ | 0.283 λ₀ |
| 32 | TiO₂ | 0.263 λ₀ |
| 33 | SiO₂ | 0.283 λ₀ |
| 34 | TiO₂ | 0.263 λ₀ |
| 35 | SiO₂ | 0.28 λ₀ |
| 36 | TiO₂ | 0.256 λ₀ |
| 37 | SiO₂ | 0.138 λ₀ |

(Air layer)
λ₀ = 847 nm

FIG. 17 shows spectral transmittance characteristics (characteristics of the film alone) according to the design of the example (2)-1. According to this design, the following characteristics were obtained.

High-reflectance band for an incident-angle of 0 degrees: 715.2 to 1011.6 nm

High-reflectance bandwidth for an incident-angle of 0 degrees: 296.4 nm

Shift of the half-value wavelength E2_{L} at the shorter-wavelength-side edge of the reflection band between the case where the incident angle is 0 degrees (characteristic A) and the case where the incident angle is 25 degrees (characteristic D): 20 nm

Average refractive index of the entire stack film: 1.75

According to this design, since the difference in refractive index between the films 38 and 40 is large compared with the first dielectric multilayer films 30 according to the examples (1)-1 to (1)-5, the reflection band is wider than that of the first dielectric multilayer film 30.

### Example (2)-2

The second dielectric multilayer film 32 was designed using the following parameters.

Substrate: glass (having a refractive index of 1.51 and an attenuation coefficient of 0)

Film 38: SiO₂ (having a refractive index of 1.45 and an attenuation coefficient of 0)

Film 40: Nb₂O₅ (having a refractive index of 2.30 and an attenuation coefficient of 0)

Number of layers: 37

Reference wavelength (center wavelength of the reflection band) λo: 825.5 nm

The thickness of each layer is shown in Table 7.

TABLE 7

| | | |
|---|---|---|
| | | optical |
| Layer No. | Material | thickness (nd) |

(Substrate)

| | | |
|---|---|---|
| 1 | SiO₂ | 0.1 λ₀ |
| 2 | Nb₂O₅ | 0.258 λ₀ |
| 3 | SiO₂ | 0.264 λ₀ |
| 4 | Nb₂O₅ | 0.233 λ₀ |
| 5 | SiO₂ | 0.248 λ₀ |
| 6 | Nb₂O₅ | 0.224 λ₀ |
| 7 | SiO₂ | 0.244 λ₀ |
| 8 | Nb₂O₅ | 0.225 λ₀ |
| 9 | SiO₂ | 0.244 λ₀ |
| 10 | Nb₂O₅ | 0.225 λ₀ |
| 11 | SiO₂ | 0.244 λ₀ |
| 12 | Nb₂O₅ | 0.225 λ₀ |
| 13 | SiO₂ | 0.244 λ₀ |
| 14 | Nb₂O₅ | 0.225 λ₀ |
| 15 | SiO₂ | 0.244 λ₀ |
| 16 | Nb₂O₅ | 0.231 λ₀ |
| 17 | SiO₂ | 0.255 λ₀ |
| 18 | Nb₂O₅ | 0.244 λ₀ |
| 19 | SiO₂ | 0.273 λ₀ |
| 20 | Nb₂O₅ | 0.274 λ₀ |
| 21 | SiO₂ | 0.295 λ₀ |
| 22 | Nb₂O₅ | 0.285 λ₀ |
| 23 | SiO₂ | 0.298 λ₀ |
| 24 | Nb₂O₅ | 0.285 λ₀ |
| 25 | SiO₂ | 0.298 λ₀ |
| 26 | Nb₂O₅ | 0.285 λ₀ |
| 27 | SiO₂ | 0.298 λ₀ |
| 28 | Nb₂O₅ | 0.285 λ₀ |
| 29 | SiO₂ | 0.298 λ₀ |
| 30 | Nb₂O₅ | 0.285 λ₀ |
| 31 | SiO₂ | 0.298 λ₀ |
| 32 | Nb₂O₅ | 0.285 λ₀ |
| 33 | SiO₂ | 0.298 λ₀ |
| 34 | Nb₂O₅ | 0.282 λ₀ |
| 35 | SiO₂ | 0.291 λ₀ |
| 36 | Nb₂O₅ | 0.272 λ₀ |
| 37 | SiO₂ | 0.142 λ₀ |

(Air layer)
λ₀ = 825.5 nm

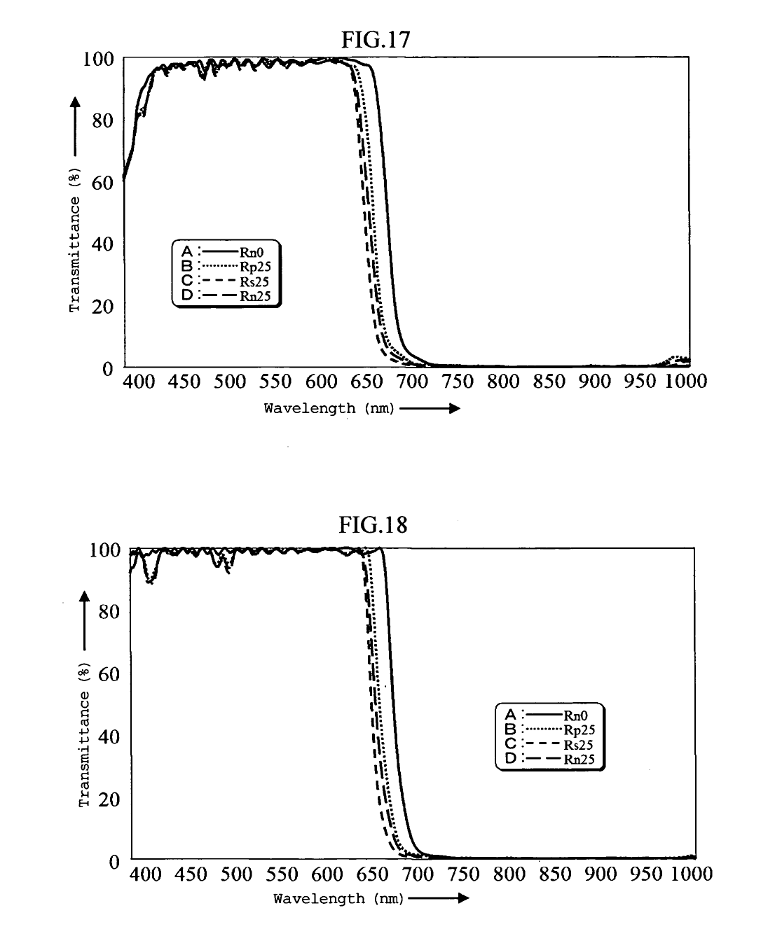

FIG. 18 shows spectral transmittance characteristics (characteristics of the film alone) according to the design of the example (2)-2. According to this design, the following characteristics were obtained.

High-reflectance band for an incident-angle of 0 degrees: 711.1 to 1091.6 nm

High-reflectance bandwidth for an incident-angle of 0 degrees: 380. 5 nm

Shift of the half-value wavelength E2_{L} at the shorter-wavelength-side edge of the reflection band between the case where the incident angle is 0 degrees (characteristic A) and the case where the incident angle is 25 degrees (characteristic D): 19.7 nm

Average refractive index of the entire stack film: 1.77

According to this design, since the difference in refractive index between the films 38 and 40 is large compared with the first dielectric multilayer films 30 according to the examples (1)-1 to (1)-5, the reflection band is wider than that of the first dielectric multilayer film 30.

(3) Examples of IR Cut Filter 26

Examples of the entire IR cut filter 26 composed of a combination of any of the first dielectric multilayer films 30 according to the examples (1)-1 to (1)-5 and any of the second dielectric multilayer films 32 according to the examples (2)-1 and (2)-2 described above will be described. In any of the following examples, simulation was performed using B270-Superwhite manufactured by SCHOTT AG in Germany (having a refractive index of 1.52 (550 nm) and a thickness of 0.3 mm) as the substrate 28.

### Example (3)-1

The IR cut filter 26 was designed using the first dielectric multilayer film 30 and the second dielectric multilayer film 32 according to the following examples.

First dielectric multilayer film 30: example (1)-1 (average refractive index of the entire stack film=1.94)

Second dielectric multilayer film 32: example (2)-1 (average refractive index of the entire stack film=1.75)

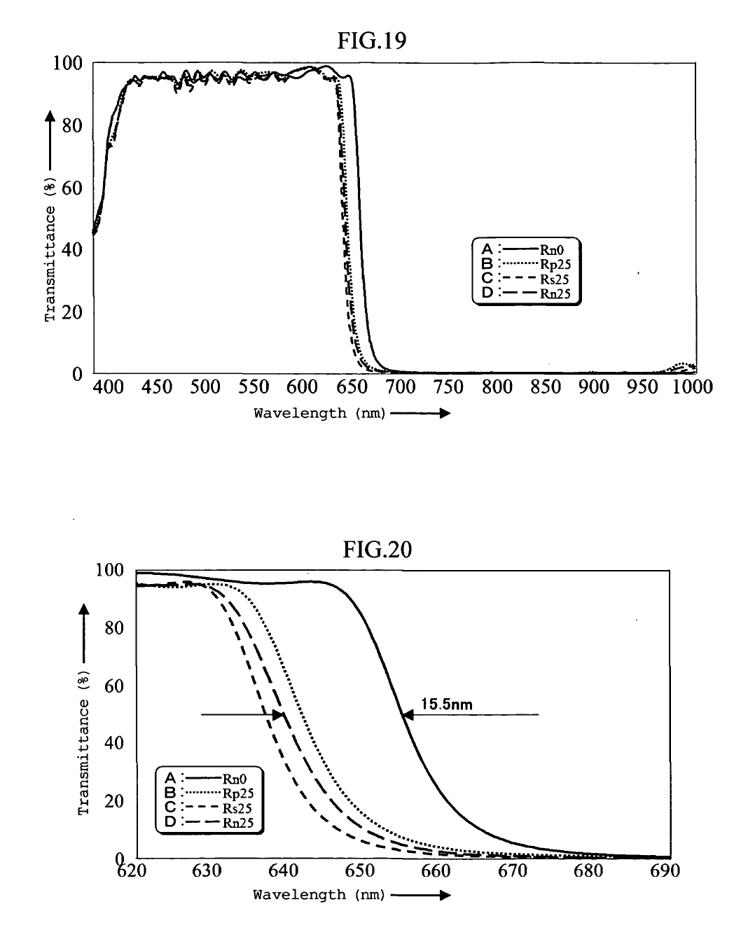

FIG. 19 shows spectral transmittance characteristics of the IR cut filter 26 of this design. FIG. 20 is an enlarged view showing the spectral transmittance characteristics within a band of 620 to 690 nm in FIG. 19. According to this design, the following characteristics were obtained.

High-reflectance band for an incident-angle of 0 degrees: 685.2 to 1010.6 nm

High-reflectance bandwidth for an incident-angle of 0 degrees: 325.4 nm

Shift of the half-value wavelength E_{L} at the shorter-wavelength-side edge of the reflection band between the case where the incident angle is 0 degrees (characteristic A) and the case where the incident angle is 25 degrees (characteristic D): 15.5 nm

### Example (3)-2

The IR cut filter 26 was designed using the first dielectric multilayer film 30 and the second dielectric multilayer film 32 according to the following examples.

First dielectric multilayer film 30: example (1)-1 (average refractive index of the entire stack film=1.94)

Second dielectric multilayer film 32: example (2)-2 (average refractive index of the entire stack film=1.77)

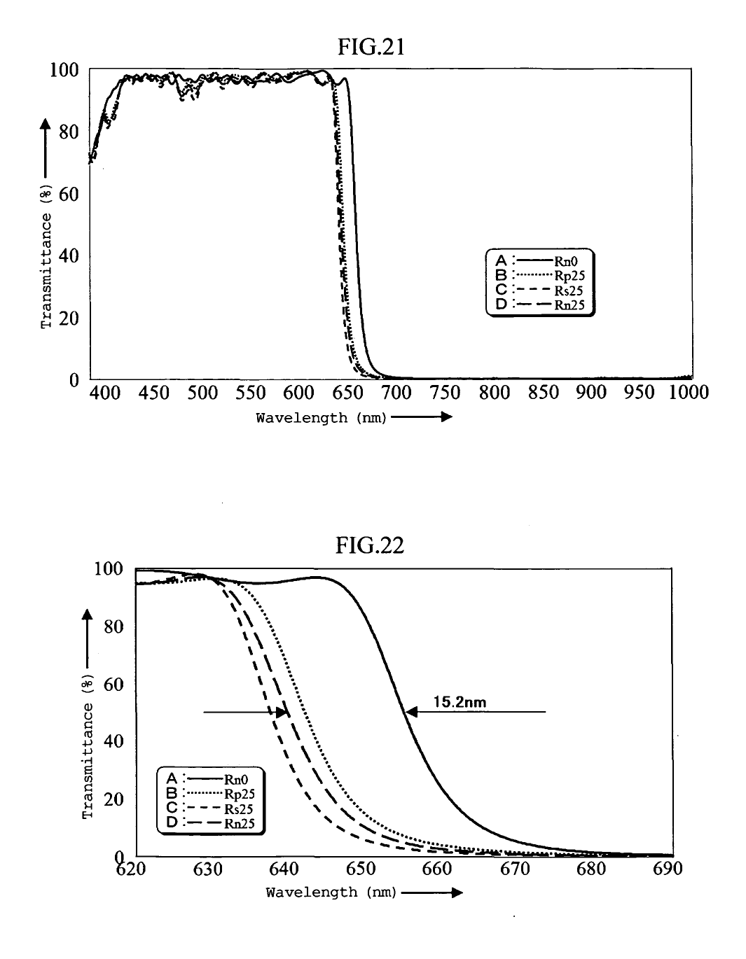

FIG. 21 shows spectral transmittance characteristics of the IR cut filter 26 of this design. FIG. 22 is an enlarged view showing the spectral transmittance characteristics within a band of 620 to 690 nm in FIG. 21. According to this design, the following characteristics were obtained.

High-reflectance band for an incident-angle of 0 degrees: 685.9 to 1091.6 nm

High-reflectance bandwidth for an incident-angle of 0 degrees: 405.7 nm

Shift of the half-value wavelength E_{L} at the shorter-wavelength-side edge of the reflection band between the case where the incident angle is 0 degrees (characteristic A) and the case where the incident angle is 25 degrees (characteristic D): 15.2 nm

### Example (3)-3

The IR cut filter 26 was designed using the first dielectric multilayer film 30 and the second dielectric multilayer film 32 according to the following examples.

First dielectric multilayer film 30: example (1)-2 (average refractive index of the entire stack film=1.96)

Second dielectric multilayer film 32: example (2)-2 (average refractive index of the entire stack film=1.77)

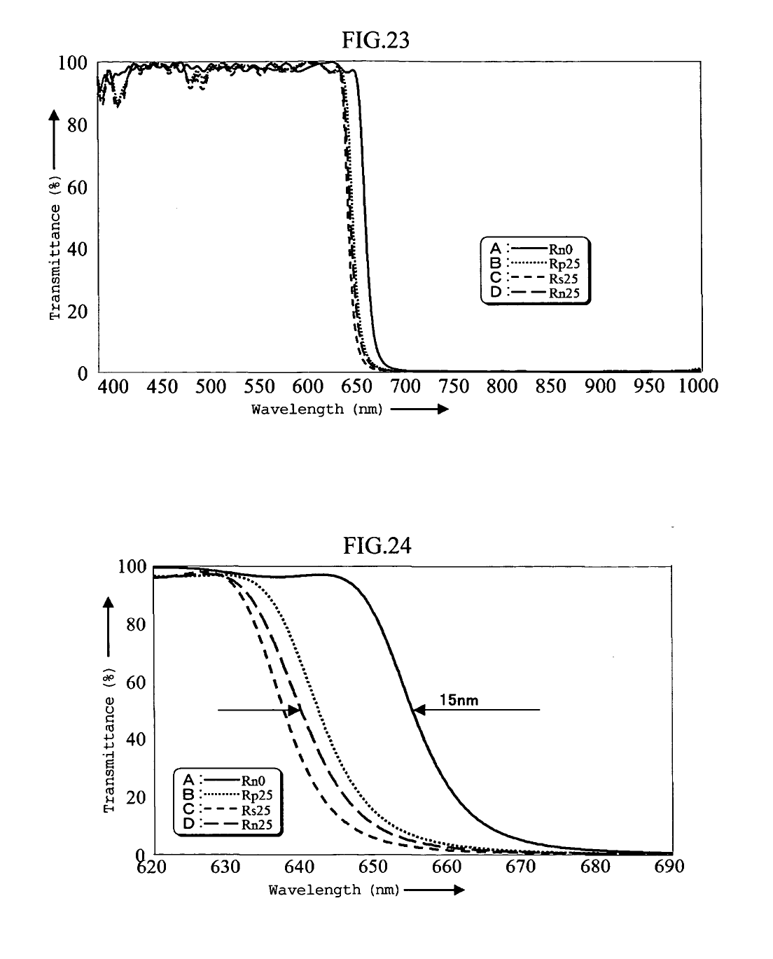

FIG. 23 shows spectral transmittance characteristics of the IR cut filter 26 of this design. FIG. 24 is an enlarged view showing the spectral transmittance characteristics within a band of 620 to 690 nm in FIG. 23. According to this design, the following characteristics were obtained.

High-reflectance band for an incident-angle of 0 degrees: 683.9 to 1092.1 nm

High-reflectance bandwidth for an incident-angle of 0 degrees: 408.2 nm

Shift of the half-value wavelength E_{L} at the shorter-wavelength-side edge of the reflection band between the case where the incident angle is 0 degrees (characteristic A) and the case where the incident angle is 25 degrees (characteristic D): 15 nm

### Example (3)-4

The IR cut filter 26 was designed using the first dielectric multilayer film 30 and the second dielectric multilayer film 32 according to the following examples.

First dielectric multilayer film 30: example (1)-3 (average refractive index of the entire stack film=2.00)

Second dielectric multilayer film 32: example (2)-1 (average refractive index of the entire stack film=1.75)

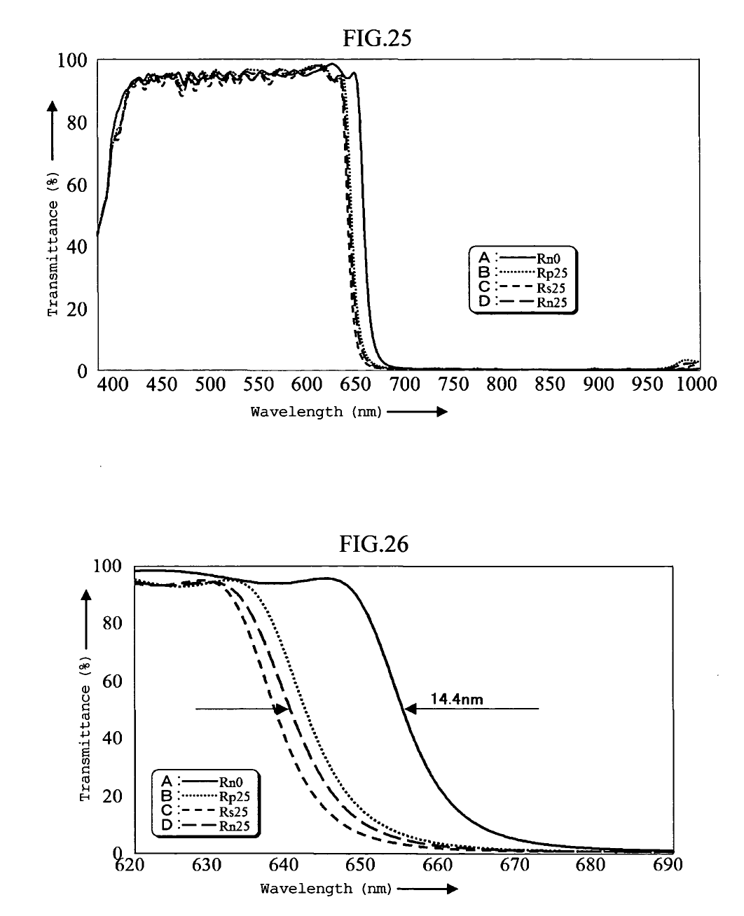

FIG. 25 shows spectral transmittance characteristics of the IR cut filter 26 of this design. FIG. 26 is an enlarged view showing the spectral transmittance characteristics within a band of 620 to 690 nm in FIG. 25. According to this design, the following characteristics were obtained.

High-reflectance band for an incident-angle of 0 degrees: 683.8 to 1011.5 nm

High-reflectance bandwidth for an incident-angle of 0 degrees: 327.7 nm

Shift of the half-value wavelength E_{L} at the shorter-wavelength-side edge of the reflection band between the case where the incident angle is 0 degrees (characteristic A) and the case where the incident angle is 25 degrees (characteristic D): 14.4 nm

### Example (3)-5

The IR cut filter 26 was designed using the first dielectric multilayer film 30 and the second dielectric multilayer film 32 according to the following examples.

First dielectric multilayer film 30: example (1)-4 (average refractive index of the entire stack film=2.05)

Second dielectric multilayer film 32: example (2)-1 (average refractive index of the entire stack film=1.75)

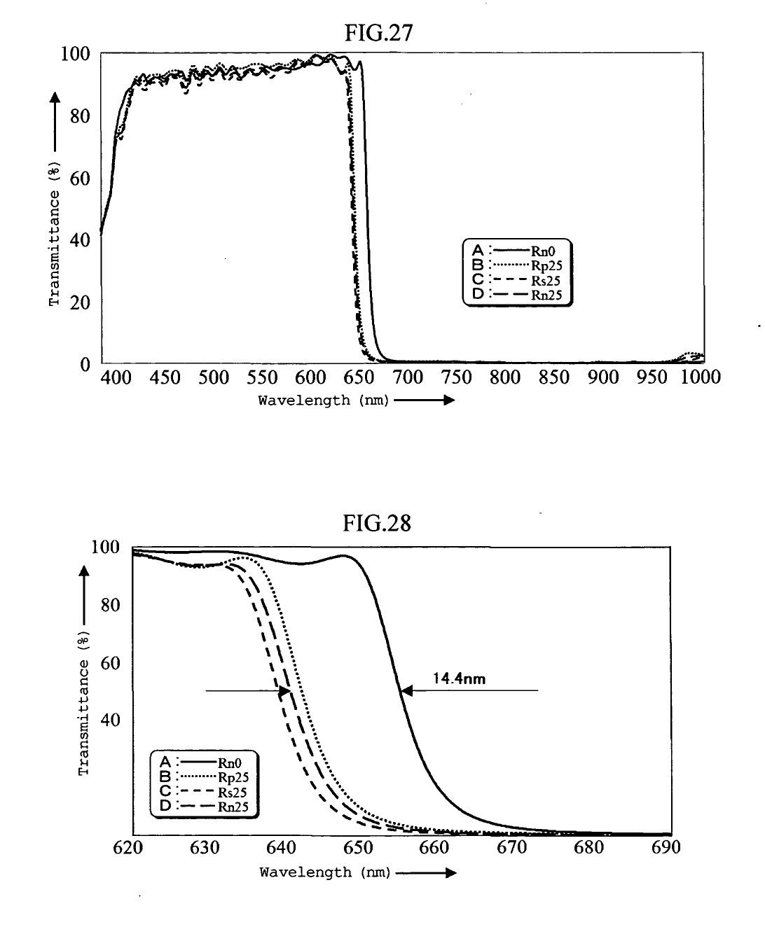

FIG. 27 shows spectral transmittance characteristics of the IR cut filter 26 of this design. FIG. 28 is an enlarged view showing the spectral transmittance characteristics within a band of 620 to 690 nm in FIG. 27. According to this design, the following characteristics were obtained.

High-reflectance band for an incident-angle of 0 degrees: 677 to 1011.1 nm

High-reflectance bandwidth for an incident-angle of 0 degrees: 334.1 nm

Shift of the half-value wavelength E_{L} at the shorter-wavelength-side edge of the reflection band between the case where the incident angle is 0 degrees (characteristic A) and the case where the incident angle is 25 degrees (characteristic D): 14.4 nm

### Example (3)-6

The IR cut filter 26 was designed using the first dielectric multilayer film 30 and the second dielectric multilayer film 32 according to the following examples.

First dielectric multilayer film 30: example (1)-5 (average refractive index of the entire stack film=2.17)

Second dielectric multilayer film 32: example (2)-2 (average refractive index of the entire stack film=1.77)

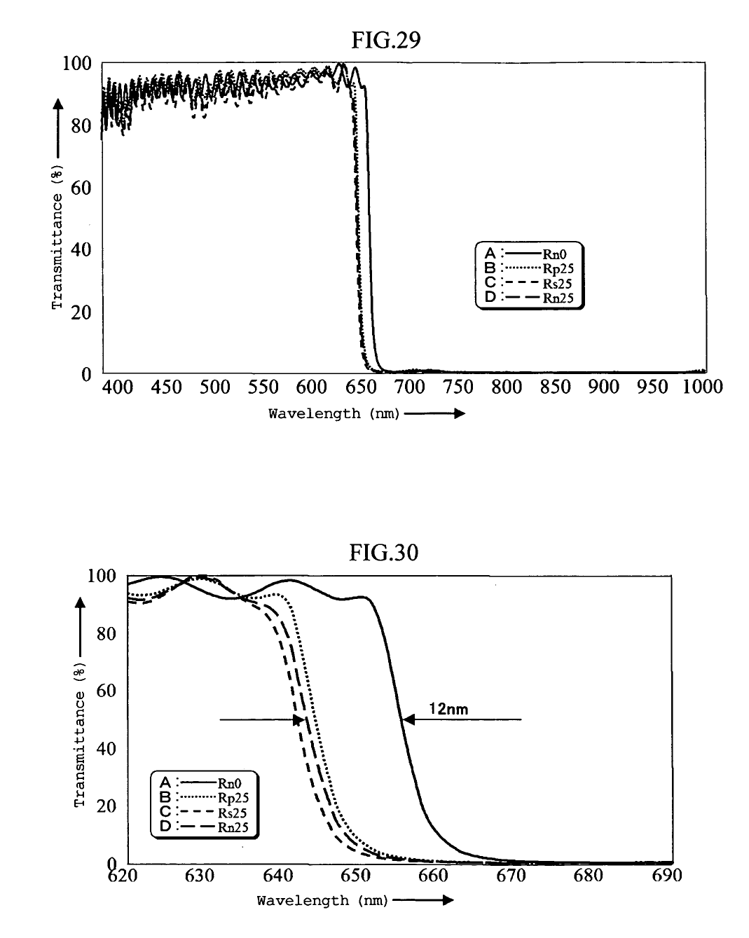

FIG. 29 shows spectral transmittance characteristics of the IR cut filter 26 of this design. FIG. 30 is an enlarged view showing the spectral transmittance characteristics within a band of 620 to 690 nm in FIG. 29. According to this design, the following characteristics were obtained.

High-reflectance band for an incident-angle of 0 degrees: 677.2 to 1011.6 nm

High-reflectance bandwidth for an incident-angle of 0 degrees: 334.4 nm

Shift of the half-value wavelength E_{L} at the shorter-wavelength-side edge of the reflection band between the case where the incident angle is 0 degrees (characteristic A) and the case where the incident angle is 25 degrees (characteristic D): 12 nm

(4) Comparison of Characteristics with IR Cut Filter of Conventional Configuration

Simulation was performed for an IR cut filter conventionally configured according to the following design.

Substrate: glass (having a refractive index of 1.52 and an attenuation coefficient of 0)

Dielectric multilayer film on the front surface of the substrate: substrate/SiO₂ film/TiO₂ film/ . . . (repetition) . . . /SiO₂ film/air layer (this film is designed so that the half-value wavelength at the shorter-wavelength-side edge of the reflection band is 655 nm when the incident angle is 0 degrees, and the average refractive index of the entire stack film=1.78)

Number of layers of the dielectric multilayer film: 17

On the back surface of the substrate: an antireflection film is formed

According to this design, the following characteristics were obtained.

High-reflectance band for an incident-angle of 0 degrees: 689.4 to 989.1 nm

High-reflectance bandwidth for an incident-angle of 0 degrees: 299.7 nm

Shift of the half-value wavelength E_{L} at the shorter-wavelength-side edge of the reflection band between the case where the incident angle is 0 degrees (characteristic A) and the case where the incident angle is 25 degrees (characteristic D): 19.5 nm

From comparison between the IR cut filter using the conventional configuration and the IR cut filters according to the examples (3)-1 to (3)-6 of the present invention, the following conclusions are derived.

(a) In the examples (3)-1 to (3)-6 of the present invention, the shift of the half-value wavelength E_{L} at the shorter-wavelength-side edge is reduced compared with the conventional configuration. This is because the average refractive index of the entire first dielectric multilayer film 30, which defines the half-value wavelength E_{L} at the shorter-wavelength-side edge of the reflection band, in each of the examples of the present invention is set higher than the average refractive index of the conventional entire dielectric multilayer film composed of SiO₂ films and TiO₂ films. Thus, in the case where the IR cut filters according to the examples (3)-1 to (3)-6 of the present invention are applied to a CCD camera, for example, the incident-angle dependency is reduced, and variations in color tone of the image taken can be suppressed.

(b) According to the examples (3)-1 to (3)-6 of the present invention, the reflection band is equal to or wider than that of the conventional configuration. This is because, in these examples, the half-value wavelength E2_{L} at the shorter-wavelength-side edge of the reflection band of the second dielectric multilayer film 32 (FIG. 6(b)) is set 20 nm longer than the half-value wavelength E1_{L} at the shorter-wavelength-side edge of the reflection band of the first dielectric multilayer film 30 (FIG. 6(a)). In other words, the half-value wavelength E2_{L} at the shorter-wavelength-side edge of the reflection band of the second dielectric multilayer film 32 is masked by the reflection band W1 of the first dielectric multilayer film 30. Thus, the incident-angle dependency of the half-value wavelength E2_{L} at the shorter-wavelength-side edge of the reflection band of the second dielectric multilayer film 32 has no effect on the reflection characteristics of the entire element 26. As a result, the width W2 of the reflection band of the second dielectric multilayer film 32 can be set wider to increase the width W0 of the reflection band of the entire element 26 (FIG. 6(c)). Therefore, according to the examples (3)-1 to (3)-6 of the present invention, infrared light can be sufficiently blocked, so that, in the case where the IR cut filters are applied to a CCD camera, the adverse effect of infrared light on color reproduction can be reduced.

### (5) Example (4)

### Another Example of IR Cut Filter 26

An example of the entire IR cut filter 26 in which the optical thickness of the films 36 of the second dielectric material of the first dielectric multilayer film 30 is set greater than the optical thickness of the film 34 of the first dielectric material will be described.

The first dielectric multilayer film 30 was designed using the following parameters.

Substrate: glass (having a refractive index of 1.52 and an attenuation coefficient of 0)

Film 34 of the first dielectric material: complex oxide of La₂O₃ and Al₂O₃ (having a refractive index of 1.75 and an attenuation coefficient of 0)

Film 36 of the second dielectric material: TiO₂ (having a refractive index of 2.39 and an attenuation coefficient of 0)

Optical thickness ratio between film 34 and film 36: 1:1.9 (approximation)

Number of layers: 24 (an SiO₂ film (having a refractive index of 1.46 and an attenuation coefficient of 0) was formed at the top of the stack)

Reference wavelength (center wavelength of the reflection band): 509 nm

Average refractive index of the entire first dielectric multilayer film 30: 2.11

The thickness of each layer of the first dielectric multilayer film 30 is shown in Table 8.

TABLE 8

| | | |
|---|---|---|
| | | optical |
| Layer No. | Material | thickness (nd) |

(Substrate)

| | | |
|---|---|---|
| 1 | TiO₂ | 0.451 λ₀ |
| 2 | La₂O₃ + Al₂O₃ | 0.326 λ₀ |
| 3 | TiO₂ | 0.451 λ₀ |
| 4 | La₂O₃ + Al₂O₃ | 0.243 λ₀ |
| 5 | TiO₂ | 0.467 λ₀ |
| 6 | La₂O₃ + Al₂O₃ | 0.251 λ₀ |
| 7 | TiO₂ | 0.459 λ₀ |
| 8 | La₂O₃ + Al₂O₃ | 0.247 λ₀ |
| 9 | TiO₂ | 0.462 λ₀ |
| 10 | La₂O₃ + Al₂O₃ | 0.249 λ₀ |
| 11 | TiO₂ | 0.465 λ₀ |
| 12 | La₂O₃ + Al₂O₃ | 0.25 λ₀ |
| 13 | TiO₂ | 0.462 λ₀ |
| 14 | La₂O₃ + Al₂O₃ | 0.248 λ₀ |
| 15 | TiO₂ | 0.459 λ₀ |
| 16 | La₂O₃ + Al₂O₃ | 0.247 λ₀ |
| 17 | TiO₂ | 0.465 λ₀ |
| 18 | La₂O₃ + Al₂O₃ | 0.25 λ₀ |
| 19 | TiO₂ | 0.47 λ₀ |
| 20 | La₂O₃ + Al₂O₃ | 0.253 λ₀ |
| 21 | TiO₂ | 0.509 λ₀ |
| 22 | La₂O₃ + Al₂O₃ | 0.137 λ₀ |
| 23 | TiO₂ | 0.468 λ₀ |
| 24 | SiO₂ | 0.207 λ₀ |

(Air layer)
λ₀ = 509 nm

The second dielectric multilayer film 32 was designed using the following parameters.

Substrate: glass (having a refractive index of 1.51 and an attenuation coefficient of 0)

Film 38 of the third dielectric material: SiO₂ (having a refractive index of 1.46 and an attenuation coefficient of 0)

Film 40 of the fourth dielectric material: TiO₂ (having a refractive index of 2.33 and an attenuation coefficient of 0)

Optical thickness ratio between film 38 and film 40: 1:1 (approximation)

Number of layers: 42

Reference wavelength (center wavelength of the reflection band) λo: 805 nm

Average refractive index of the entire second dielectric multilayer film 32: 1.78

The thickness of each layer of the second dielectric multilayer film 32 is shown in Table 9.

TABLE 9

| | | |
|---|---|---|
| | | optical |
| Layer No. | Material | thickness (nd) |

(Substrate)

| | | |
|---|---|---|
| 1 | TiO₂ | 0.267 λ₀ |
| 2 | SiO₂ | 0.289 λ₀ |
| 3 | TiO₂ | 0.248 λ₀ |
| 4 | SiO₂ | 0.261 λ₀ |
| 5 | TiO₂ | 0.24 λ₀ |
| 6 | SiO₂ | 0.263 λ₀ |
| 7 | TiO₂ | 0.237 λ₀ |
| 8 | SiO₂ | 0.262 λ₀ |
| 9 | TiO₂ | 0.237 λ₀ |
| 10 | SiO₂ | 0.258 λ₀ |
| 11 | TiO₂ | 0.238 λ₀ |
| 12 | SiO₂ | 0.258 λ₀ |
| 13 | TiO₂ | 0.237 λ₀ |
| 14 | SiO₂ | 0.261 λ₀ |
| 15 | TiO₂ | 0.235 λ₀ |
| 16 | SiO₂ | 0.261 λ₀ |
| 17 | TiO₂ | 0.236 λ₀ |
| 18 | SiO₂ | 0.261 λ₀ |
| 19 | TiO₂ | 0.239 λ₀ |
| 20 | SiO₂ | 0.263 λ₀ |
| 21 | TiO₂ | 0.242 λ₀ |
| 22 | SiO₂ | 0.268 λ₀ |
| 23 | TiO₂ | 0.25 λ₀ |
| 24 | SiO₂ | 0.279 λ₀ |
| 25 | TiO₂ | 0.273 λ₀ |
| 26 | SiO₂ | 0.299 λ₀ |
| 27 | TiO₂ | 0.283 λ₀ |
| 28 | SiO₂ | 0.294 λ₀ |
| 29 | TiO₂ | 0.27 λ₀ |
| 30 | SiO₂ | 0.284 λ₀ |
| 31 | TiO₂ | 0.267 λ₀ |
| 32 | SiO₂ | 0.292 λ₀ |
| 33 | TiO₂ | 0.28 λ₀ |
| 34 | SiO₂ | 0.297 λ₀ |
| 35 | TiO₂ | 0.275 λ₀ |
| 36 | SiO₂ | 0.286 λ₀ |
| 37 | TiO₂ | 0.261 λ₀ |
| 38 | SiO₂ | 0.278 λ₀ |
| 39 | TiO₂ | 0.262 λ₀ |
| 40 | SiO₂ | 0.285 λ₀ |
| 41 | TiO₂ | 0.266 λ₀ |
| 42 | SiO₂ | 0.143 λ₀ |

(Air Layer)
λ₀ = 805 nm

FIG. 32 shows spectral transmittance characteristics (actual measurements) of the IR cut filter 26 of the design according to this example (4) for an incident angle of 0 degrees (normal incident angle). In FIG. 32, characteristics A, B and C represent the following transmittances, respectively.

Characteristic A: transmittance of n-polarized light (average of p-polarized light and s-polarized light) of the first dielectric multilayer film 30 alone

Characteristic B: transmittance of n-polarized light of the second dielectric multilayer film 32 alone

Characteristic C: transmittance of n-polarized light of the entire IR cut filter 26

As can be seen from the characteristic C of the entire IR cut filter 26 shown in FIG. 32, a reflection band required for the IR cut filter was obtained.

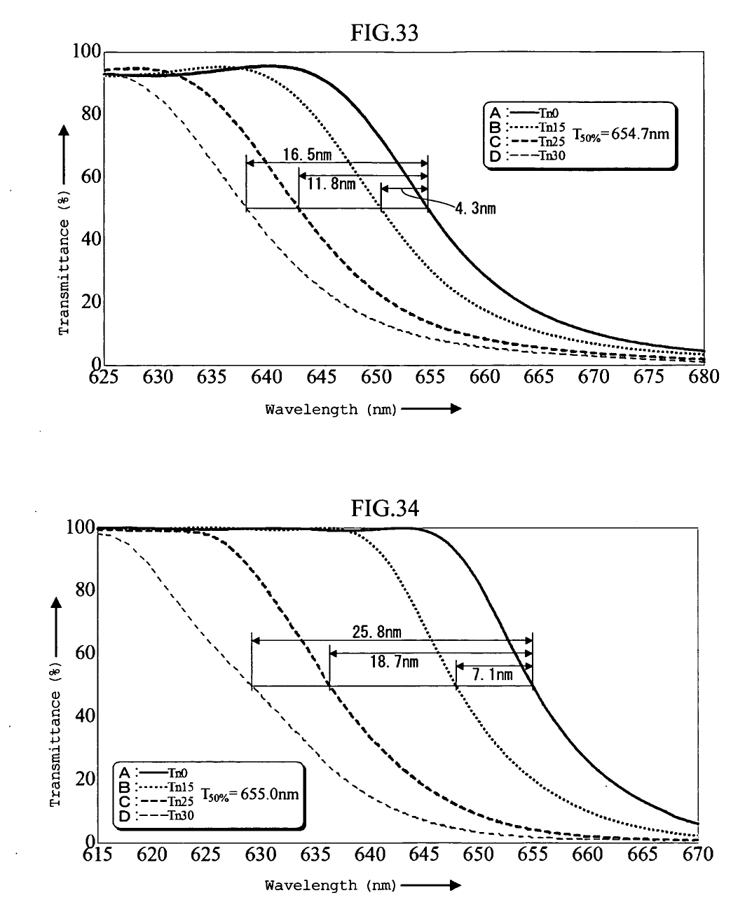

FIG. 33 is an enlarged view showing spectral transmittance characteristics (actual measurements) of the IR cut filter 26 of the design according to this example (4) (characteristics of the entire IR cut filter 26) within a band of 625 nm to 680 nm for varied incident angles. In FIG. 33, characteristics A, B, C and D represent the following transmittances, respectively.

Characteristic A: transmittance of n-polarized light for an incident angle of 0 degrees

Characteristic B: transmittance of n-polarized light for an incident angle of 15 degrees

Characteristic C: transmittance of n-polarized light for an incident angle of 25 degrees

Characteristic D: transmittance of n-polarized light for an incident angle of 30 degrees

As can be seen from FIG. 33, the shifts of the half-value wavelength at the shorter-wavelength-side edge of the reflection band for the characteristics B, C and D from the half-value wavelength (654.7 nm) at the shorter-wavelength-side edge of the reflection band for the characteristic A (incident angle=0 degrees) were as follows.

Shift for the characteristic B (incident angle=15 degrees): 4.3 nm

Shift for the characteristic C (incident angle=25 degrees): 11.8 nm

Shift for the characteristic D (incident angle=30 degrees): 16.5 nm

As a comparison example, FIG. 34 is an enlarged view showing spectral transmittance characteristics (simulation values) of an IR cut filter using a conventional dielectric multilayer film within a band of 625 to 680 nm for varied incident angles. The IR cut filter is composed of a substrate made of an optical glass, a stack of low-refractive-index films of SiO₂ and high-refractive-index films of TiO₂ alternately deposited on the front surface of the substrate, and an antireflection film formed on the back surface of the substrate. In FIG. 34, characteristics A, B, C and D represent the following transmittances, respectively.

Characteristic A: transmittance of n-polarized light for an incident angle of 0 degrees

Characteristic B: transmittance of n-polarized light for an incident angle of 15 degrees

Characteristic C: transmittance of n-polarized light for an incident angle of 25 degrees

Characteristic D: transmittance of n-polarized light for an incident angle of 30 degrees

As can be seen from FIG. 34, the shifts of the half-value wavelength at the shorter-wavelength-side edge of the reflection band for the characteristics B, C and D from the half-value wavelength (655.0 nm) at the shorter-wavelength-side edge of the reflection band for the characteristic A (incident angle=0 degrees) were as follows.

Shift for characteristic B (incident angle=15 degrees): 7.1 nm

Shift for the characteristic C (incident angle=25 degrees): 18.7 nm

Shift for the characteristic D (incident angle=30 degrees): 25.8 nm

From comparison between FIGS. 33 and 34, it can be seen that, compared with the conventional design, the shift from the half-value wavelength at the shorter-wavelength-side edge of the reflection band for the incident angle of 0 degrees is improved in the example (4) by

2.8 nm (=7.1 nm−4.3 nm) for the incident angle of 15 degrees,

6.9 nm (=18.7 nm−11.8 nm) for the incident angle of 25 degrees, and

9.3 nm (=25.8 nm−16.5 nm) for the incident angle of 30 degrees.

### (6) Example (5)

### Example of Red-Reflective Dichroic Filter

An example of a red-reflective dichroic filter composed of the dielectric multilayer filter 26 shown in FIG. 1 will be described.

The first dielectric multilayer film 30 was designed using the following parameters.

Substrate: glass (having a refractive index of 1.52 and an attenuation coefficient of 0)

Film 34 of the first dielectric material: complex oxide of La₂O₃ and Al₂O₃ (having a refractive index of 1.70 and an attenuation coefficient of 0)

Film 36 of the second dielectric material: Ta₂O₅ (having a refractive index of 2.16 and an attenuation coefficient of 0)

Optical thickness ratio between film 34 and film 36: 0.5:2 (1:4) (approximation)

Number of layers: 43

Reference wavelength (center wavelength of the reflection band): 533 nm

Average refractive index of the entire first dielectric multilayer film 30: 2.04

The thickness of each layer of the first dielectric multilayer film 30 is shown in Table 10.

TABLE 10

| | | |
|---|---|---|
| | | optical |
| Layer No. | Material | thickness (nd) |

(Substrate)

| | | |
|---|---|---|
| 1 | La₂O₃ + Al₂O₃ | 0.158 λ₀ |
| 2 | Ta₂O₅ | 0.459 λ₀ |
| 3 | La₂O₃ + Al₂O₃ | 0.143 λ₀ |
| 4 | Ta₂O₅ | 0.524 λ₀ |
| 5 | La₂O₃ + Al₂O₃ | 0.131 λ₀ |
| 6 | Ta₂O₅ | 0.517 λ₀ |
| 7 | La₂O₃ + Al₂O₃ | 0.129 λ₀ |
| 8 | Ta₂O₅ | 0.509 λ₀ |
| 9 | La₂O₃ + Al₂O₃ | 0.127 λ₀ |
| 10 | Ta₂O₅ | 0.51 λ₀ |
| 11 | La₂O₃ + Al₂O₃ | 0.128 λ₀ |
| 12 | Ta₂O₅ | 0.504 λ₀ |
| 13 | La₂O₃ + Al₂O₃ | 0.126 λ₀ |
| 14 | Ta₂O₅ | 0.508 λ₀ |
| 15 | La₂O₃ + Al₂O₃ | 0.127 λ₀ |
| 16 | Ta₂O₅ | 0.501 λ₀ |
| 17 | La₂O₃ + Al₂O₃ | 0.125 λ₀ |
| 18 | Ta₂O₅ | 0.505 λ₀ |
| 19 | La₂O₃ + Al₂O₃ | 0.126 λ₀ |
| 20 | Ta₂O₅ | 0.505 λ₀ |
| 21 | La₂O₃ + Al₂O₃ | 0.126 λ₀ |
| 22 | Ta₂O₅ | 0.499 λ₀ |
| 23 | La₂O₃ + Al₂O₃ | 0.125 λ₀ |
| 24 | Ta₂O₅ | 0.508 λ₀ |
| 25 | La₂O₃ + Al₂O₃ | 0.127 λ₀ |
| 26 | Ta₂O₅ | 0.498 λ₀ |
| 27 | La₂O₃ + Al₂O₃ | 0.125 λ₀ |
| 28 | Ta₂O₅ | 0.503 λ₀ |
| 29 | La₂O₃ + Al₂O₃ | 0.126 λ₀ |
| 30 | Ta₂O₅ | 0.508 λ₀ |
| 31 | La₂O₃ + Al₂O₃ | 0.127 λ₀ |
| 32 | Ta₂O₅ | 0.493 λ₀ |
| 33 | La₂O₃ + Al₂O₃ | 0.123 λ₀ |
| 34 | Ta₂O₅ | 0.513 λ₀ |
| 35 | La₂O₃ + Al₂O₃ | 0.128 λ₀ |
| 36 | Ta₂O₅ | 0.499 λ₀ |
| 37 | La₂O₃ + Al₂O₃ | 0.125 λ₀ |
| 38 | Ta₂O₅ | 0.495 λ₀ |
| 39 | La₂O₃ + Al₂O₃ | 0.124 λ₀ |
| 40 | Ta₂O₅ | 0.493 λ₀ |
| 41 | La₂O₃ + Al₂O₃ | 0.223 λ₀ |
| 42 | Ta₂O₅ | 0.254 λ₀ |
| 43 | La₂O₃ + Al₂O₃ | 0.227 λ₀ |

(Air layer)
λ₀ = 533 nm

The second dielectric multilayer film 32 was designed using the following parameters.

Substrate: glass (having a refractive index of 1.51 and an attenuation coefficient of 0)

Film 38: SiO₂ (having a refractive index of 1.45 and an attenuation coefficient of 0)

Film 40: Ta₂O₅ (having a refractive index of 2.03 and an attenuation coefficient of 0)

Optical thickness ratio between film 38 and film 40: 1:1 (approximation)

Number of layers: 14

Reference wavelength (center wavelength of the reflection band) λo: 780 nm

Average refractive index of the entire second dielectric multilayer film 32: 1.68

The thickness of each layer of the second dielectric multilayer film 32 is shown in Table 11.

TABLE 11

| | | |
|---|---|---|
| | | Optical |
| Layer No. | Material | thickness (nd) |

(Substrate)

| | | |
|---|---|---|
| 1 | Ta₂O₅ | 0.276 λ₀ |
| 2 | SiO₂ | 0.285 λ₀ |
| 3 | Ta₂O₅ | 0.244 λ₀ |
| 4 | SiO₂ | 0.268 λ₀ |
| 5 | Ta₂O₅ | 0.237 λ₀ |
| 6 | SiO₂ | 0.268 λ₀ |
| 7 | Ta₂O₅ | 0.237 λ₀ |
| 8 | SiO₂ | 0.268 λ₀ |
| 9 | Ta₂O₅ | 0.237 λ₀ |
| 10 | SiO₂ | 0.268 λ₀ |
| 11 | Ta₂O₅ | 0.234 λ₀ |
| 12 | SiO₂ | 0.288 λ₀ |
| 13 | Ta₂O₅ | 0.197 λ₀ |
| 14 | SiO₂ | 0.144 λ₀ |

(Air layer)
λ₀ = 780 nm

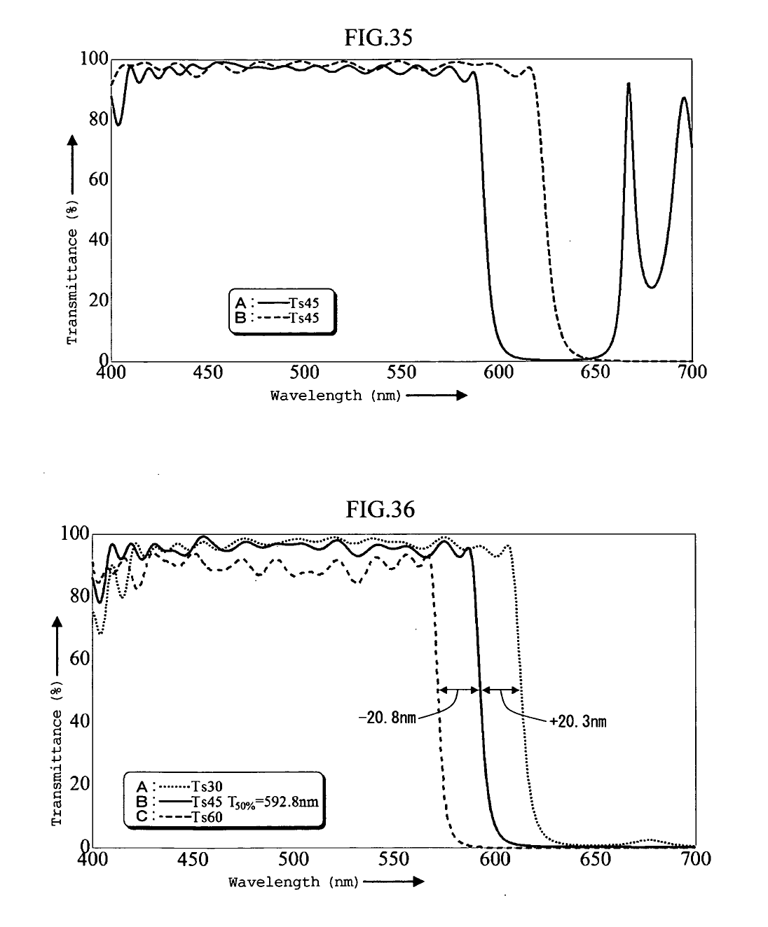

FIG. 35 shows spectral transmittance characteristics (simulation values) of the red-reflective dichroic filter 26 of the design according to this example (5) for an incident angle of 45 degrees (normal incident angle). In FIG. 35, characteristics A and B represent the following transmittances, respectively.

Characteristic A: transmittance of s-polarized light of the first dielectric multilayer film 30 alone

Characteristic B: transmittance of s-polarized light of the second dielectric multilayer film 32 alone

As can be seen from FIG. 35, as the reflection band of the entire red-reflective dichroic filter 26, which is a combination of the reflection bands for the characteristics A and B, a reflection band required for the IR cut filter was obtained.

FIG. 36 shows spectral transmittance characteristics of the entire red-reflective dichroic filter 26 of the design according to this example (5) (simulation values) for varied incident angles. In FIG. 36, characteristics A, B and C represent the following transmittances, respectively.

Characteristic A: transmittance of s-polarized light for an incident angle of 30 degrees (=normal incident angle−15 degrees)

Characteristic B: transmittance of s-polarized light for an incident angle of 45 degrees (=normal incident angle)

Characteristic C: transmittance of s-polarized light for an incident angle of 60 degrees (=normal incident angle+15 degrees)

As can be seen from FIG. 36, the shifts of the half-value wavelength at the shorter-wavelength-side edge of the reflection band for the characteristics A and C from the half-value wavelength (592.8 nm) at the shorter-wavelength-side edge of the reflection band for the characteristic B (incident angle=45 degrees) were as follows.

Shift for the characteristic A (incident angle=30 degrees): +20.3 nm

Shift for the characteristic C (incident angle=60 degrees): −20.8 nm

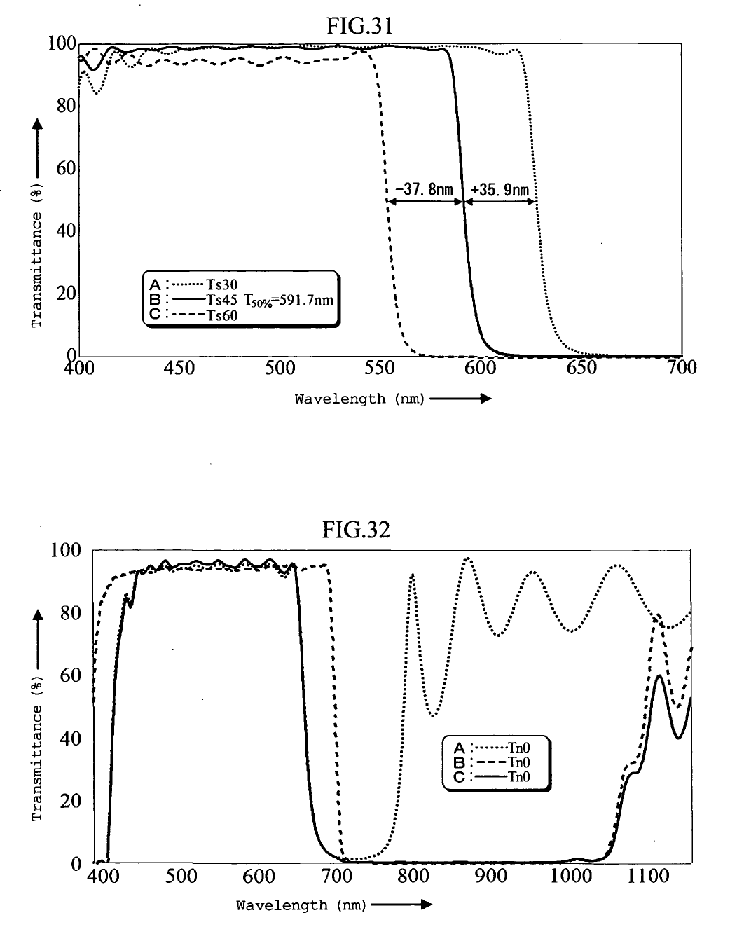

As a comparison example, as can be seen from FIG. 31 (characteristics of a red-reflective dichroic filter using a conventional dielectric multilayer film) described earlier, the shifts of the half-value wavelength at the shorter-wavelength-side edge of the reflection band for the characteristics A and C from the half-value wavelength (591.7 nm) at the shorter-wavelength-side edge of the reflection band for the characteristic B (incident angle=45 degrees) were as follows.

Shift for the characteristic A (incident angle=30 degrees): +35.9 nm

Shift for the characteristic C (incident angle=60 degrees): −37.8 nm

From comparison between FIGS. 31 and 36, it can be seen that, compared with the conventional design, the shift from the half-value wavelength at the shorter-wavelength-side edge of the reflection band for the incident angle of 45 degrees is improved in the example (5) by

15.6 nm (=35.9 nm−20.3 nm) for the incident angle of 30 degrees, and

17.0 nm (=37.8 nm−20.8 nm) for the incident angle of 60 degrees.

In the case where the optical thickness of the film 36 of the second dielectric material in the first dielectric multilayer film 30 is set greater than the optical thickness of the film 34 of the first dielectric material, the optical thickness ratio between the film 34 and the film 36 is approximately 1:1.9 in the example (4) and approximately 1:4 in the example (5). However, various optical thickness ratios, such as 1:1.5 (2:3) and 1:3, are possible.

In the dielectric multilayer filters 26 according to the embodiment described above, the first dielectric multilayer film 30 is formed on the front surface (incidence plane of light) 28a of the transparent substrate 28, and the second dielectric multilayer film 32 is formed on the back surface 28b. However, the second dielectric multilayer film 32 may be formed on the front surface 28a, and the first dielectric multilayer film 30 may be formed on the back surface 28b.

In the embodiment described above, cases where the present invention is applied to the IR cut filter and the red-reflective dichroic filter have been described. However, the present invention can also be applied to any other filters (other edge filters, for example) that require suppression of the incident-angle dependency and a wide reflection band.

What is claimed is:

1. A dielectric multilayer filter comprising:
a transparent substrate;
a first dielectric multilayer film having a predetermined reflection band formed on one surface of said transparent substrate; and
a second dielectric multilayer film having a predetermined reflection band formed on the other surface of said transparent substrate,
wherein the width of the reflection band of said first dielectric multilayer film is set narrower than the width of the reflection band of said second dielectric multilayer film, and
the shorter-wavelength-side edge of the reflection band of said second dielectric multilayer film is set between the shorter-wavelength-side edge and the longer-wavelength-side edge of the reflection band of said first dielectric multilayer film.

2. The dielectric multilayer filter according to claim 1, wherein the average refractive index of the whole of said first dielectric multilayer film is set higher than the average refractive index of the whole of said second dielectric multilayer film.

3. The dielectric multilayer filter according to claim 1, wherein said first dielectric multilayer film has a structure including films of a first dielectric material having a predetermined refractive index and films of a second dielectric material having a refractive index higher than that of the first dielectric material that are alternately stacked,
said second dielectric multilayer film has a structure including films of a third dielectric material having a predetermined refractive index and films of a fourth dielectric material having a refractive index higher than that of the third dielectric material that are alternately stacked, and
the difference in refractive index between said first dielectric material and said second dielectric material is set smaller than the difference in refractive index between said third dielectric material and said fourth dielectric material.

4. The dielectric multilayer filter according to claim 3, wherein said first dielectric material has a refractive index of 1.60 to 2.10 for light having a wavelength of 550 nm,
said second dielectric material has a refractive index of 2.0 or higher for light having a wavelength of 550 nm,
said third dielectric material has a refractive index of 1.30 to 1.59 for light having a wavelength of 550 nm, and
said fourth dielectric material has a refractive index of 2.0 or higher for light having a wavelength of 550 nm.

5. The dielectric multilayer filter according to claim 4, wherein said second dielectric material is any of TiO₂, Nb₂O₅ and Ta₂O₅ or a complex oxide mainly containing any of TiO₂, Nb₂O₅ and Ta₂O₅,
said third dielectric material is SiO₂, and
said fourth dielectric material is any of TiO₂, Nb₂O₅ and Ta₂O₅ or a complex oxide mainly containing any of TiO₂, Nb₂O₅ and Ta₂O₅.

6. The dielectric multilayer filter according to claim 4, wherein said first dielectric material is any of Bi₂O₃, Ta₂O₅, La₂O₃, Al₂O₃, SiOₓ (x≦1), LaF₃, a complex oxide of La₂O₃ and Al₂O₃ and a complex oxide of Pr₂O₃ and Al₂O₃, or a complex oxide of two or more of these materials.

7. The dielectric multilayer filter according to claim 3, wherein, in said first dielectric multilayer film, the optical thickness of the films of said second dielectric material is set greater than the optical thickness of the films of said first dielectric material.

8. The dielectric multilayer filter according to claim 7, wherein the value of “(the optical thickness of the films of the second dielectric material)/(the optical thickness of the films of the first dielectric material)” is greater than 1.0 and equal to or smaller than 4.0.

9. The dielectric multilayer filter according to claim 1, wherein the dielectric multilayer filter is an infrared cut filter that transmits visible light and reflects infrared light.

10. The dielectric multilayer filter according to claim 1, wherein the dielectric multilayer filter is a red-reflective dichroic filter that reflects red light.
